(19) United States
(12) Patent Application Publication
(10) Pub. No.: US 2026/0330454 A1
(43) Pub. Date: Oct. 22, 2026

(54) Systems and Methods for Asymmetric Post-Quantum Ownership Proof, Recovery, and Quantum-Hardening of Blockchain Assets

(71) Applicant: James P. Tagg, Encinitas, CA (US)

(72) Inventors: James P Tagg, Encinitas, CA (US); Benjamin Murphy, Shoreham-by-Sea (GB)

(21) Appl. No.: 19/690,012

(22) Filed: May 27, 2026

Related U.S. Application Data
(60) Provisional application No. 63/818,575, filed on Jun. 5, 2025.
(60) Provisional application No. 63/834,401, filed on Jul. 3, 2025.
(60) Provisional application No. 63/856,104, filed on Aug. 1, 2025.
(60) Provisional application No. 63/859,254, filed on Aug. 7, 2025.
(60) Provisional application No. 63/865,342, filed on Aug. 17, 2025.

(51) Int. Cl. G06Q 20/38

(52) U.S. Cl. CPC G06Q 20/38215; G06Q 20/3823; G06Q 20/389

(57) ABSTRACT

A system preserves ownership continuity for blockchain assets after compromise of classical public-key cryptography by using asymmetric ownership evidence not obtainable merely from an exposed public key. A wallet, chain-native protocol, recovery service, or quantum-hardening factory automatically evaluates or supplies proof material, converts vulnerable assets into post-quantum-protected control, and authorizes migration, release, adjudication, or recovery. The proof material may include HD wallet seed or derivation-path evidence, zero-knowledge seed proofs, post-quantum signatures, timestamped watermark commitments such as QD3 records, transaction-origin receipts, custody logs, court or arbitration attestations, and challenge-period results. The system may operate through upgraded validating nodes, proof-gated smart contracts, post-quantum wallet software, protective custody, distributed management ledgers, token wrappers, vaults, bridges, or stable coin contracts. Recovery policies distinguish rightful owners from quantum attackers and preserve owner rights during post-quantum migration.

### INCORPORATION BY REFERENCE

Each patent, patent application, publication, technical standard, and other document cited in this application is incorporated by reference to the extent permitted by applicable law and rules. If incorporated material conflicts with the express disclosure of this application, the express disclosure of this application controls.

### STATEMENT REGARDING FEDERALLY SPONSORED RESEARCH OR DEVELOPMENT

No invention claimed herein was made with government support. Federally sponsored research or development is not applicable.

### STATEMENT REGARDING JOINT RESEARCH AGREEMENT

Not applicable.

### STATEMENT REGARDING SEQUENCE LISTING OR COMPUTER PROGRAM LISTING

No sequence listing is included. No computer program listing is submitted as a separate appendix.

### INTERPRETATION

Unless the context clearly requires otherwise, words in the singular include the plural and words in the plural include the singular. The terms “including,” “comprising,” and “having” are open-ended and mean including without limitation. The term “or” is inclusive unless expressly stated otherwise.

### TECHNICAL FIELD

The disclosure relates to post-quantum cryptographic systems for blockchain networks. More specifically, the disclosure relates to privacy-preserving ownership commitments for pre-quantum blockchain assets, post-quantum key binding, protective custody of quantum-vulnerable assets, recovery and arbitration workflows, wallet-layer quantum-safe transaction construction, and zero-knowledge or post-quantum ownership verification for cryptocurrency assets.

### BACKGROUND

Public blockchain systems commonly rely on elliptic curve cryptography to authenticate control of assets. Bitcoin uses ECDSA and Schnorr signatures over the secp256k1 elliptic curve. Ethereum and many other blockchain systems similarly rely on elliptic curve signatures. A sufficiently capable quantum computer running Shor's algorithm can derive an elliptic curve private key from a corresponding public key. Once a public key has been exposed on-chain, an adversary with such quantum capability may be able to sign transactions and transfer assets without authorization from the legitimate owner.

Blockchain assets differ in the timing and manner of public key exposure. Some Bitcoin outputs, including pay-to-public-key outputs and certain multisignature constructions, expose public keys before spending. Reused addresses may retain funds after a prior spend exposed the public key. Taproot outputs expose public keys in ways that create quantum-transition concerns. Hash-based address types such as P2PKH and P2WPKH generally conceal the public key until a spend occurs, but the spend itself creates a vulnerability window if a quantum adversary can derive and use the private key before the legitimate transaction receives finality or before change outputs are moved away from exposed keys.

Post-quantum cryptographic algorithms such as ML-DSA, formerly CRYSTALS-Dilithium, provide quantum-resistant signature mechanisms. However, existing blockchain assets were not created under post-quantum signature schemes. Migration to quantum-safe ownership creates several problems. A user may need to prove control of a pre-quantum address without revealing the very public key the user seeks to protect. Dormant owners, deceased owners, heirs, custodians, and lost-wallet claimants may need to establish priority or legitimacy after quantum computers have compromised conventional private-key evidence. A network-wide protocol change may not be available soon enough, may not be accepted by all users, or may not address assets whose owners are unavailable.

Existing migration proposals often assume a direct transfer from a vulnerable address to a quantum-safe address. That assumption fails for dormant assets, inherited assets, lost-key assets, addresses whose public keys must remain concealed, and assets whose private keys become indistinguishable from keys derived by a quantum attacker. Further, a public registration system that publishes an address, an existing ECDSA or Schnorr public key, or a full post-quantum public key may reduce privacy or create new attack surfaces.

Existing blockchain systems rely on classical public-key signatures for control of blockchain assets. Proposals for post-quantum migration have included migration to post-quantum signature schemes, commit-reveal mechanisms, freezing or restricting vulnerable outputs, and recovery mechanisms based on information not available to a party that merely derives a classical private key from an exposed public key. These approaches leave unresolved implementation questions concerning confidential pre-event ownership commitments, multi-asset registration, recovery-policy evaluation, custody coordination, and preservation of ownership rights for dormant or unavailable owners.

There is therefore a need for a system that can create a timestamped evidentiary anchor for an existing blockchain asset before or during a quantum transition, without requiring a consensus change, without spending the protected asset, and without revealing sensitive address or key material at registration time. There is also a need for the evidentiary anchor to support later migration, recovery, protective custody, arbitration, fork-recognition, and claim-resolution processes.

### SUMMARY

The disclosure provides a unified system for preserving ownership continuity for blockchain assets as they transition from pre-quantum to post-quantum security. In one embodiment, a user generates post-quantum claim material for an existing blockchain asset and records a timestamped commitment to that material on a public ledger. The commitment, referred to in some embodiments as QD3, may be public or confidential. In a preferred confidential embodiment, the protected address and existing ECDSA or Schnorr public key are not published. Instead, the commitment includes salted hashes or other cryptographic commitments to an address identifier, post-quantum public-key material, post-quantum signature material, claim context, policy data, or recovery metadata.

The protected asset need not be spent to create the commitment. A separate funding address, relay, service provider, third-party transaction, OP_RETURN output, Taproot commitment, inscription-like metadata record, sidechain record, rollup commitment, or other timestamped public-ledger anchoring mechanism may record the commitment. The owner retains salts and claim material privately. Later, during a migration, recovery, arbitration, protective-custody proceeding, fork-recognition process, or other quantum-transition event, the owner or claimant reveals selected claim material. Verifiers recompute the commitment, validate post-quantum signatures or zero-knowledge proofs, confirm timestamp priority, and determine whether the revealed material corresponds to the earlier on-chain commitment.

In some embodiments, QD3 supports confidential batch registration for multiple addresses. A wallet forms address-level claim records, salts and hashes the records into leaves, and records only a Merkle root or accumulator root on-chain. Later, the owner reveals only the relevant address-level claim and proof path. The rest of the batch remains confidential. Padding, decoy leaves, blinded leaves, or fixed-size batches may obscure the number and identity of protected addresses.

In some embodiments, the QD3 commitment is used by a Quantum Secure Asset Verification and Escrow system, referred to in some embodiments as QSAVE. QSAVE may identify quantum-vulnerable addresses, classify assets by exposure status, monitor quantum-threat thresholds, create protective custody addresses, coordinate distributed multisignature or threshold custodians, maintain audit trails, and provide owner recovery workflows. Protective custody may be opt-in, pre-authorized, legally supervised, or applied under an applicable lost-property or emergency-preservation framework. In each case, the system preserves ownership claims and prevents unilateral custodian control.

In some embodiments, a recovery framework evaluates claims using one or more of QD3 commitments, post-quantum signatures, hierarchical deterministic wallet derivation-path evidence, zero-knowledge proofs of wallet seed knowledge, pre-break signed messages, wallet backups, transaction history, exchange records, inheritance records, identity attestations, social attestations, stake-backed claims, challenge windows, and blind arbitration. Because quantum-derived private keys may no longer prove legitimate ownership, the recovery framework gives weight to evidence that existed before a relevant quantum event or migration cutoff.

In some embodiments, a blockchain protocol upgrade, such as a soft fork, adds a two-factor spending rule for selected assets after a threshold time, block height, threat trigger, or migration phase. Under the two-factor rule, spending the asset requires both a valid classical signature under the existing elliptic-curve key and a valid zero-knowledge proof that the spender knows a wallet seed, derivation path, or seed-derived secret that produces the address, public-key hash, script descriptor, or account corresponding to the asset. The proof requirement is enforced by upgraded validating nodes according to consensus or policy rules and does not require contacting a QSAVE service, custodian, exchange, or other external recovery system.

In some embodiments, a post-quantum-hardened hierarchical-deterministic wallet created by a wallet factory automatically supplies the additional proof required by the two-factor rule. The wallet may derive the relevant address from a BIP-39 seed, BIP-32 path, BIP-44 path, BIP-84 path, BIP-86 path, EVM path, hardware-wallet descriptor, or other wallet descriptor; generate the zero-knowledge proof, proof reference, or proof commitment; attach the proof data to the transaction or to an associated witness, annex, extension field, script path, proof channel, or sidecar record recognized by upgraded node software; and submit the transaction for normal network validation. In this manner, a user who still possesses the original wallet seed or wallet device may satisfy the added chain-native proof factor with minimal manual effort.

In some embodiments, the chain-native protocol upgrade verifies a QD3-backed claim without requiring QSAVE server involvement. A user or wallet may previously record a QD3 commitment, QD3 root, Merkle root, accumulator root, Taproot commitment, OP_RETURN record, sidechain commitment, rollup commitment, or other timestamped commitment recognized by upgraded node software or by a consensus-recognized commitment index. After a trigger, a spending transaction may include reveal material such as a salt, domain separator, asset identifier, address identifier, post-quantum public-key hash, claim context, policy descriptor, zero-knowledge proof, post-quantum signature, Merkle proof, accumulator witness, or other proof material. Upgraded validating nodes recompute or verify the commitment against the earlier timestamped record and accept the spend when the chain-native QD3 rule is satisfied. This QD3-backed chain-native path may operate independently of protective custody, arbitration, claim portals, or external recovery services.

In other embodiments, where assets have instead been moved into protective custody or where no consensus-level two-factor rule exists, a wallet, wallet plug-in, recovery client, hardware-wallet companion, exchange wallet, custodian system, or browser wallet may automatically generate or submit asymmetric ownership evidence to a wallet policy engine, exchange, custodian, distributed management ledger, recovery contract, arbitrator, fork-recognition process, or QSAVE claim portal. The evidence may include a zero-knowledge proof, signed recovery message, wallet-derived proof, QD3 reveal, Merkle proof, post-quantum signature, or other proof package. These off-chain, custody, or recovery embodiments are distinct from the chain-native two-factor soft-fork embodiment.

In some embodiments, a Post-Quantum Pay wallet-layer protocol, referred to in some embodiments as PQP, intercepts or constructs outgoing transactions so that all funds controlled by an exposed or soon-to-be-exposed address are swept to quantum-safe outputs and no change returns to a quantum-exposed address. The transaction may include a QD3 attestation, child-pays-for-parent capability, replacement or fee-management logic, and warnings for address types that cannot be made quantum-safe without protocol changes.

The system may operate without requiring an immediate blockchain consensus change while remaining compatible with future soft forks, hard forks, sidechains, rollups, post-quantum opcodes, quantum-safe address formats, proof-gated smart contracts, and other post-quantum migration mechanisms.

### BRIEF DESCRIPTION OF THE DRAWINGS

FIG. 1 illustrates an overall ownership-continuity architecture including a protected blockchain asset, a QD3 commitment generator, a public-ledger timestamp anchor, a QSAVE protective custody platform, and recovery or arbitration verifiers.

FIG. 2 illustrates a confidential QD3 registration flow in which a protected asset is not spent, sensitive address material is not revealed, and a separate funding transaction records a commitment.

FIG. 3 illustrates a confidential QD3 commitment data structure including a domain separator, salt, address identifier commitment, post-quantum public-key hash, post-quantum signature hash, claim context, and policy fields.

FIG. 4 illustrates a confidential batch registration structure in which address-level claims form salted Merkle leaves and only a Merkle or accumulator root is timestamped on-chain.

FIG. 5 illustrates a later reveal and verification process in which selected claim material, a salt, post-quantum public key, post-quantum signature material, and Merkle proof are verified against an earlier QD3 root.

FIG. 6 illustrates QSAVE protective custody workflows including vulnerability detection, threat-threshold evaluation, protective address generation, distributed custodian signature control, audit logging, and owner claim processing.

FIG. 7 illustrates a recovery and arbitration framework using asymmetric ownership evidence, QD3 evidence, post-quantum signatures, zero-knowledge wallet proofs, documentary evidence, stake-backed claims, challenge windows, a distributed management ledger, and final settlement.

FIG. 8 illustrates a PQP transaction flow in which a wallet constructs a transaction that pays a recipient, sweeps all change to quantum-safe outputs, optionally records QD3 data, and provides CPFP fee-bump capability.

FIG. 9 illustrates an inheritance or dormant-wallet scenario in which pre-quantum ownership evidence is used after a quantum event to distinguish a legitimate claimant from a quantum attacker.

FIG. 10 illustrates optional integration with proof-gated account-based blockchain contracts, vault layers, ERC-20 compatible wrappers, or ERC-21 style quantum-locked transfer functions.

FIG. 11 illustrates a compact QD3 record byte-layout including a header, version, algorithm identifier, post-quantum public-key hash, post-quantum signature hash, and attestation field.

FIG. 12 illustrates a zero-knowledge proof circuit architecture having private witness inputs, public inputs, hash verification gates, ownership predicate constraints, witness computation, and an on-chain or off-chain verification path.

FIG. 13 illustrates a protocol timeline from initial vulnerability assessment through user commitment creation, blockchain confirmation, security delay, quantum threat detection, protective custody activation, and owner recovery with appreciation.

FIG. 14 illustrates a documentary wallet recovery state machine including evidence submission, validation, arbitration triggers, competing claims, final resolution, and fund distribution.

FIG. 15 illustrates a Taproot dual-leaf construction having a provably unspendable internal key and a script tree comprising a classical spending leaf and a quantum-safe spending leaf, with commitment-reveal trigger conditions and Merkle-proof verification.

FIG. 16 illustrates a proposed OP_QCLAIM script structure including script-version bytes, an operation code, commitment-hash validation, classical and quantum signature verification paths, time-lock conditions, and OP_NOP fallback.

FIG. 17 illustrates a non-sovereign wealth fund architecture including aggregation of protected funds, a smart-contract pool, multi-jurisdiction governance, conservative yield strategies, principal-preservation reserves, public-goods allocation, and an owner-claim portal.

FIG. 18 illustrates a Lightning-Network protection architecture including channel-state monitoring, pre-signed PQP-compliant emergency closures, watchtower storage, recursive child-pays-for-parent templates, cooperative migration, and non-cooperative enforcement.

FIG. 19 illustrates a liquidity-pool quantum migration framework including liquidity-provider position identification, impermanent-loss-aware migration timing, flash-loan orchestration, atomic migration execution, yield preservation, and cross-protocol coordination.

FIG. 20 illustrates a unified hierarchical-deterministic derivation architecture in which a single BIP-39 seed produces, through domain-separated key derivation functions, both an elliptic-curve keypair following BIP-32 or BIP-44 paths and a post-quantum keypair.

FIG. 21 illustrates a three-layer token custody architecture comprising a token layer, a vault layer, and an identity layer where balances are keyed by hash commitments of hierarchical deterministic seeds, together with deposit, withdrawal, and internal-transfer functions.

FIG. 22 illustrates a quantum-vault construction including a smart-contract vault, a commitment to a wallet seed or post-quantum public key, a quantum-lock state, a proof-gated transfer function, and a recovery policy.

FIG. 23 illustrates an asymmetric ownership evidence hierarchy comprising seed evidence, timestamped watermark evidence, transaction-origin evidence, and third-party attestation evidence evaluated against blockchain history and a recovery policy.

FIG. 24 illustrates a quantum-hardening factory for automatically converting vulnerable wallet, token, account, bridge, custodial, or transaction-flow assets into post-quantum-protected control.

FIG. 25 illustrates a post-quantum stable coin and quantum-resistant bridge system using reserve, ledger, authorization, mint/burn/redeem, bridge, proof-gated authorization, recovery, and audit modules.

FIG. 26 illustrates a quantum threat projection timeline including present classical-key exposure, quantum capability growth, migration deadline signals, projected breakthrough windows, urgent protection periods, and a post-quantum stability phase.

FIG. 27 illustrates a complete quantum protection user journey from a vulnerable wallet or asset through threat detection, voluntary migration, QD3 watermarking, QSAVE protective custody for dormant assets, wealth-fund aggregation where applicable, and owner recovery with appreciation.

FIG. 28 illustrates multi-chain zero-knowledge ownership verification including a BIP-39 seed witness, Bitcoin derivation and off-chain verification without a consensus change, Ethereum derivation and on-chain smart-contract verification, post-quantum key binding, and a common proof policy.

FIG. 29 illustrates quantum attack resistance by comparing a quantum attacker who derives a classical private key from an exposed public key with a rightful owner who proves seed knowledge, pre-break watermarking, origin records, or other asymmetric ownership evidence.

FIG. 30 illustrates token hot-mode and safe-mode deposit and withdrawal flows, together with a cross-chain security boundary in which bridge lock, burn, mint, release, proof verification, reserve reconciliation, and recovery paths are controlled by post-quantum or proof-gated authorization.

FIG. 31 illustrates a recovery process within the overall framework, showing a preparation phase, a perceived-threat phase, a quantum-break event, an intervening uncertain gap, a hardening and registration band, break-speed severity factors, chain or community response paths, recovery and claims tiers, and resulting ownership-preserving or value-losing outcomes.

### DETAILED DESCRIPTION

### 1. Definitions

As used herein, a “pre-quantum blockchain asset” includes a cryptocurrency UTXO, account balance, token position, smart-contract position, channel balance, liquidity-provider position, staking position, governance position, or other blockchain-controlled asset whose present ownership mechanism depends at least in part on a cryptographic primitive vulnerable to a quantum computer.

A “protected asset” means a pre-quantum blockchain asset for which a commitment, claim, migration policy, custody policy, recovery policy, or post-quantum verification path has been created.

“QD3” refers to a quantum ownership watermarking or data-commitment record that anchors post-quantum claim material to a timestamped public ledger record. QD3 may be implemented as a compact byte layout, an OP_RETURN record, a Taproot commitment, an inscription-like data record, a sidechain record, a rollup commitment, an accumulator root, or another publicly timestamped commitment.

“QSAVE” refers to Quantum Secure Asset Verification and Escrow, a protective custody and recovery system that uses vulnerability detection, ownership evidence, distributed control, audit records, and claim verification to preserve assets at risk of quantum compromise.

“PQP” refers to a Post-Quantum Pay transaction process in which a wallet-layer module constructs or modifies transactions so that exposed funds are swept to quantum-safe destinations and do not remain at rest under exposed classical keys.

A “post-quantum claim material” may include a post-quantum public key, a hash of a post-quantum public key, a post-quantum signature, a hash or commitment to a post-quantum signature, a zero-knowledge proof, a commitment to a wallet seed, a derivation path, a policy descriptor, a recovery descriptor, a claimant identifier, or related metadata.

A “confidential commitment” means a cryptographic commitment that allows later verification while concealing at least one of the protected address, public key, post-quantum public key, signature material, ownership policy, recovery policy, number of protected addresses, or wallet structure before a reveal event.

### 2. System Overview

The system creates continuity between a pre-quantum ownership state and a post-quantum verification state. A user, wallet, custodian, relay, estate planner, exchange, service provider, or authorized agent prepares claim material for one or more existing blockchain assets. The system commits to the claim material on a public ledger before a relevant quantum event, migration cutoff, recovery window, arbitration deadline, fork snapshot, protective custody action, or other timestamp-sensitive event.

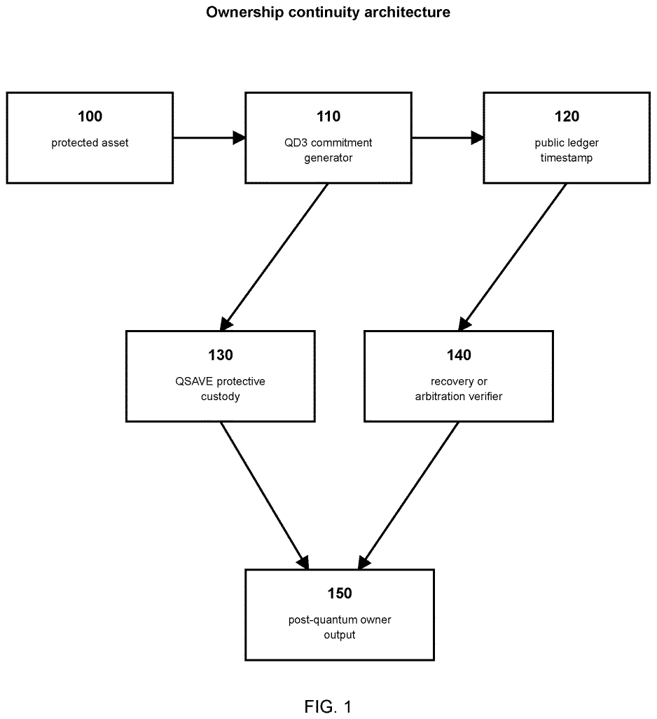

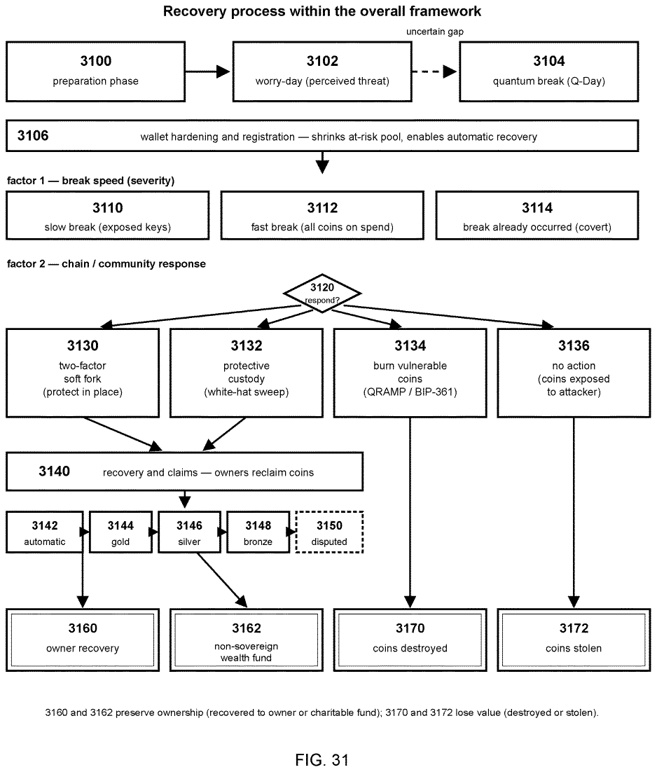

Referring to FIG. 1, a protected asset 100 is associated with a QD3 commitment generator 110 that produces a commitment anchored by a public-ledger timestamp 120. The timestamped record may later be used by QSAVE protective custody 130, by a recovery or arbitration verifier 140, or by another migration or fork-recognition process to authorize a post-quantum owner output 150. FIG. 31 shows the same continuity problem over time: a preparation phase 3100 and perceived-threat phase 3102 may precede a quantum-break event 3104, after which wallet hardening and registration 3106 may occur. Depending on whether the break follows a slow-break severity path 3110, fast-break severity path 3112, or already-occurred or covert-break severity path 3114, a chain or community response decision 3120 may select a two-factor soft fork path 3130, protective custody path 3132, burn-vulnerable-coins path 3134, or no-action path 3136. Recovery and claims processing 3140 may then proceed through automatic recovery 3142, gold-tier recovery 3144, silver-tier recovery 3146, bronze-tier recovery 3148, or a disputed-claim path 3150, leading to owner recovery 3160, a non-sovereign wealth fund outcome 3162, a coins-destroyed outcome 3170, or a coins-stolen outcome 3172.

The system separates registration from spending. For hash-protected Bitcoin addresses, requiring the protected UTXO to fund a registration transaction may reveal the address's ECDSA or Schnorr public key and thereby create the very exposure the system seeks to avoid. Accordingly, a preferred implementation records the QD3 commitment using a separate funding address, a relayer, a service-provider transaction, a sponsored transaction, a batched transaction, or a third-party anchoring service. The protected asset remains unmoved.

The on-chain record preferably does not publish the protected address or full post-quantum public key. Instead, it publishes a compact commitment, such as:
address_commitment=HASH (domain_separator ∥ salt ∥ blockchain_identifier ∥ asset_identifier ∥ post_quantum_public_key_hash ∥ claim_context ∥ policy_descriptor)

The domain separator prevents cross-protocol replay. The salt prevents dictionary attacks against likely addresses. The blockchain identifier distinguishes Bitcoin, Ethereum, sidechains, rollups, or other networks. The asset identifier may be a Bitcoin address, address hash, UTXO descriptor, script descriptor, account identifier, token contract plus account, or blinded identifier. The post-quantum public-key hash binds a later post-quantum key without publishing it. The claim context may specify migration, recovery, arbitration, protective custody, fork recognition, inheritance, custody, or other intended uses. The policy descriptor may specify reveal conditions, recovery thresholds, custodian requirements, challenge windows, threat triggers, or claim scoring rules.

At a later time, a claimant reveals selected material. A verifier recomputes the commitment and determines whether the revealed material matches the timestamped QD3 record. The verifier may also check a post-quantum signature, a zero-knowledge proof, a classical signature where safe, an HD-wallet derivation-path proof, a seed-commitment proof, documentary evidence, or an arbitration result.

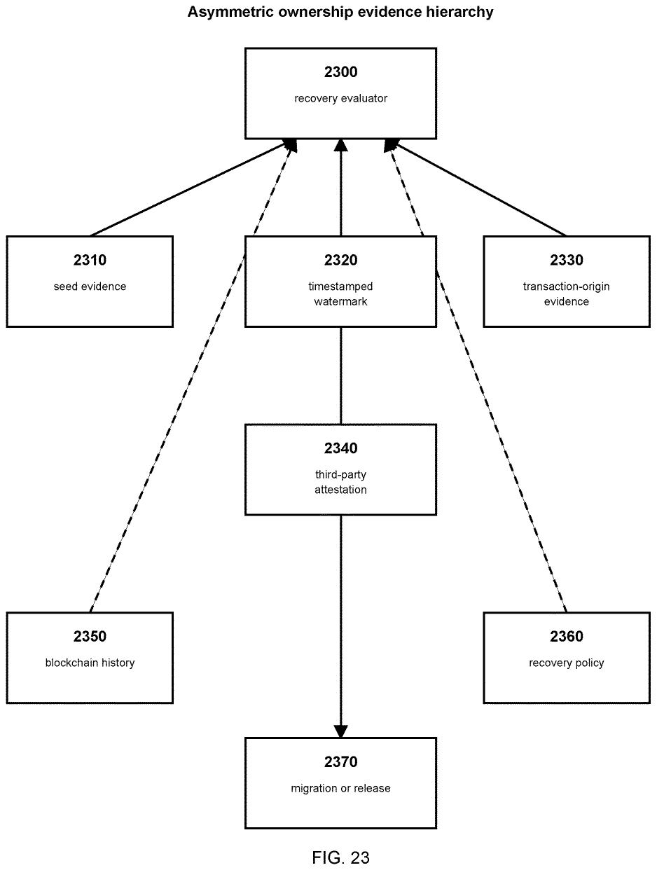

FIG. 23 illustrates the asymmetric ownership-evidence path used by the system. A recovery evaluator 2300 may receive seed evidence 2310, timestamped watermark evidence 2320, transaction-origin evidence 2330, and third-party attestation evidence 2340. The evaluator 2300 compares that evidence with blockchain history 2350 and a recovery policy 2360 to determine whether migration or release 2370 should occur.

### 3. Confidential QD3 Registration

In a confidential QD3 registration, the user generates or identifies a post-quantum key pair. The post-quantum key pair may use ML-DSA, Falcon, SLH-DSA, or another post-quantum signature algorithm. The user may generate a post-quantum signature over a claim message. The claim message may include a domain separator, blockchain identifier, asset identifier, timestamp policy, recovery policy, and intended use. Rather than publishing the full post-quantum public key or signature, the user publishes a commitment or hash.

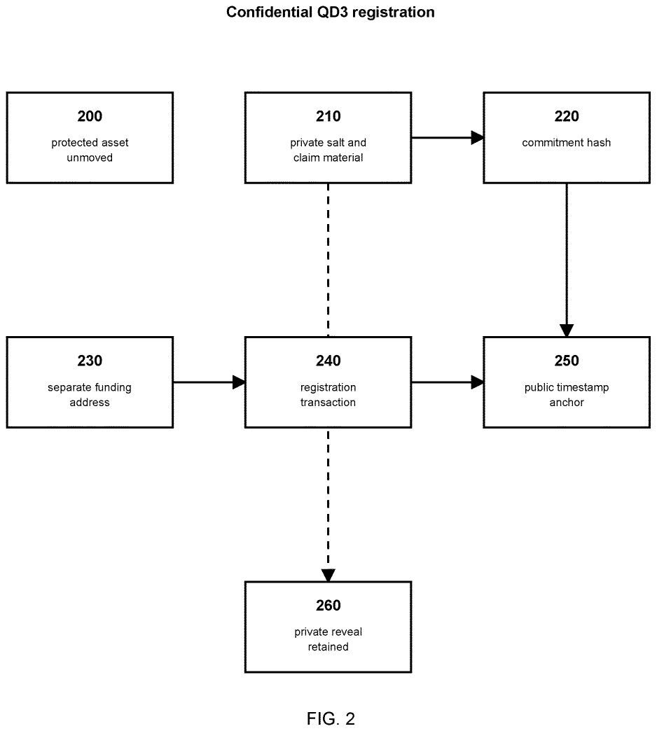

Referring to FIG. 2, a protected asset 200 remains unmoved while private salt and claim material 210 are processed into a commitment hash 220. A separate funding address 230 funds a registration transaction 240 that creates a public timestamp anchor 250. The private reveal material 260 is retained by the owner or claimant for later use. Thus, the act of registration does not require spending from the protected asset 200 or revealing its existing public key.

The registration transaction may be funded independently of the protected asset. For example, a wallet may use an unrelated Bitcoin UTXO to publish a compact OP_RETURN commitment. A service provider may batch commitments for many users and publish one root. A relayer may accept an off-chain request and sponsor the on-chain record. A smart contract, rollup, or sidechain may timestamp a commitment root. In each case, the protected UTXO or account need not be touched.

This registration creates an evidentiary anchor rather than an immediate quantum-safe spending path. The commitment itself does not make a Bitcoin address quantum-safe. It establishes that a party possessed selected claim material before a relevant event. That evidence can later be used by wallets, exchanges, custodians, courts, arbitrators, forks, sidechains, protocol-upgrade processes, or QSAVE protective custody systems.

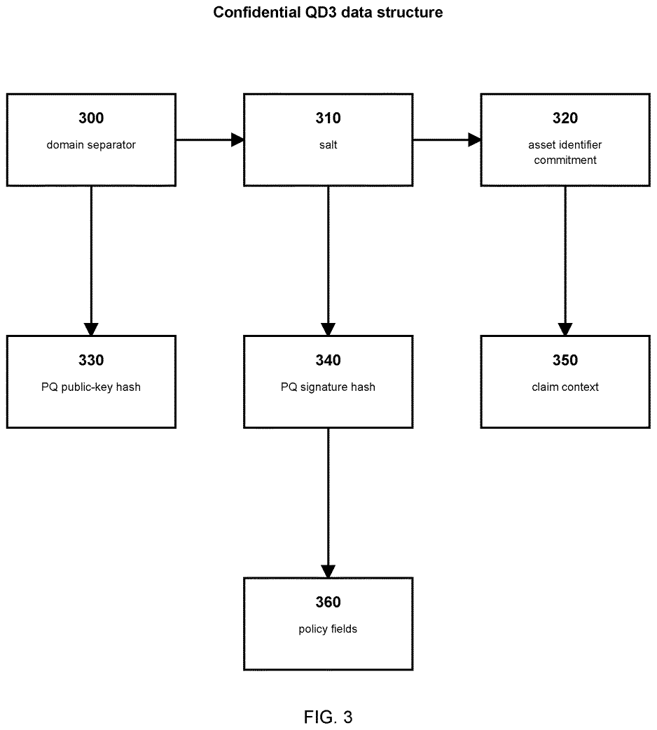

Referring to FIG. 3, a representative confidential QD3 data structure includes a domain separator 300, salt 310, asset identifier commitment 320, post-quantum public-key hash 330, post-quantum signature hash 340, claim context 350, and policy fields 360. These fields allow later verification while concealing the asset identity, full post-quantum public key, and policy details until a permitted reveal event.

### 4. Public QD3 Registration

In a public registration, some or all of the protected address, post-quantum public key, post-quantum signature, or policy descriptor may be published. Public registration may be suitable where privacy is not required, where the address public key is already exposed, where a claimant seeks public notice, or where a protocol requires transparent binding. Public registration may use the same verification structure as confidential registration but omits one or more hiding features.

The same public-registration embodiment may use the registration transaction 240 and public timestamp anchor 250 of FIG. 2, except that one or more hidden fields represented by private salt and claim material 210 or private reveal material 260 are instead published directly or stored in a publicly retrievable record.

### 5. Compact QD3 Record Formats

In some embodiments, QD3 uses a compact record sized for a Bitcoin data-carrying output. A record may include a magic header, version, algorithm identifier, post-quantum public-key hash, post-quantum signature hash, attestation flags, checksum, or policy bits. For example, a compact format may include:
a header identifying the record as QD3;
a version byte;
an algorithm identifier for ML-DSA-65 or another post-quantum algorithm;
a hash of a post-quantum public key;
a hash of post-quantum signature material;
attestation flags identifying public, confidential, batch, recovery, custody, migration, or fork-recognition uses.

The compact record may store a direct commitment or a root commitment to more extensive off-chain or separately stored data. The invention is not limited to a specific byte count, header, or blockchain data field.

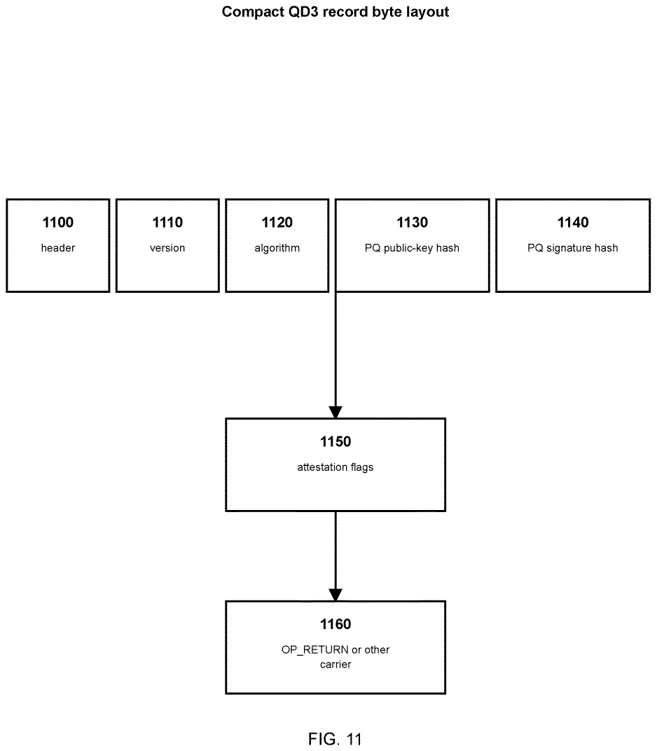

Referring to FIG. 11, a compact QD3 record may include a header 1100, version field 1110, algorithm field 1120, post-quantum public-key hash 1130, post-quantum signature hash 1140, attestation flags 1150, and an OP_RETURN or other carrier 1160. The fields of FIG. 11 provide a concrete on-chain representation for the more general commitment structures described herein.

### 5.1 Preferred Seventy-Three-Byte QD3 Record Layout

In a preferred Bitcoin embodiment, the QD3 record is a seventy-three-byte structure that fits within Bitcoin's eighty-byte OP_RETURN data-carrying output, leaving seven bytes available for operation codes, length prefixes, and protocol overhead. A representative layout comprises the following fields:

| Offset (bytes) | Length (bytes) | Field name | Description |
|---|---|---|---|
| 0-2 | 3 | Header | ASCII “QD3” |
| | | | (hexadecimal |
| | | | 0x514433), enabling |
| | | | rapid identification of |
| | | | quantum protection |
| | | | records when |
| | | | scanning the |
| | | | blockchain |
| 3 | 1 | Version | Format version byte |
| | | | (e.g., 0x02 for version |
| | | | 2.0); permits |
| | | | algorithm and |
| | | | structural agility |
| 4 | 1 | Algorithm | Identifies the post- |
| | | identifier | quantum signature |
| | | | algorithm (e.g., 0x01 |
| | | | for ML-DSA-65, |
| | | | 0x02 for Falcon-512, |
| | | | 0x03 for SLH-DSA, |
| | | | 0x04 for ML-DSA- |
| | | | 87, with additional |
| | | | values reserved) |
| 5-36 | 32 | Post-quantum | SHA-256 hash of the |
| | | public-key hash | post-quantum public |
| | | | key, providing a fixed |
| | | | thirty-two-byte |
| | | | fingerprint that |
| | | | conceals the |
| | | | underlying public key |
| | | | (which may be 1,952 |
| | | | bytes for ML-DSA- |
| | | | 65) until reveal |
| 37-68 | 32 | Post-quantum | SHA-256 hash of a |
| | | signature hash | post-quantum |
| | | | signature over a |
| | | | domain-separated |
| | | | binding tuple, |
| | | | demonstrating present |
| | | | control of the post- |
| | | | quantum private key |
| | | | without revealing the |
| | | | signature itself (which |
| | | | may be 3,309 bytes |
| | | | for ML-DSA-65) |
| 69-72 | 4 | Attestation | Multi-purpose field |
| | | field | providing chain |
| | | | identification (e.g., |
| | | | 0x00000000 mainnet, |
| | | | 0x00000001 testnet), |
| | | | registrar identifier |
| | | | codes, timestamp |
| | | | hints, batch flags, |
| | | | recovery flags, |
| | | | custody flags, |
| | | | migration flags, fork- |
| | | | recognition flags, and |
| | | | protocol-extension |
| | | | reserved bits |

The header value 0x514433 was selected to avoid collision with existing Bitcoin protocol markers and provides human-readable identification in hexadecimal dumps. The thirty-two-byte hash representation of the post-quantum public key both compresses the underlying material to a manageable size and provides a consistent representation regardless of the underlying post-quantum signature algorithm, enabling algorithm agility without changing the on-chain record size.

The thirty-two-byte signature hash demonstrates that the registrant possessed a valid post-quantum signature over a binding tuple at registration time, while permitting the signature itself to be retained off-chain or revealed only at claim time. This approach reduces on-chain footprint and allows the same compact record to support algorithms with substantially different signature sizes.

The four-byte attestation field permits multiple uses to coexist within the same record format: a flag bit may indicate whether the record represents a public commitment, a confidential commitment, a batch root commitment, a recovery commitment, a custody commitment, a migration commitment, or a fork-recognition commitment. Reserved bits permit later protocol extensions including but not limited to additional algorithm identifiers, additional chain identifiers, additional attestation policies, and proof-system identifiers.

### 5.2 Hash Substitution and Algorithm Agility

In some embodiments, the SHA-256 hash function used in the public-key hash and signature hash fields may be replaced with another cryptographic hash function, including but not limited to SHA-3, BLAKE2, BLAKE3, or any post-quantum-secure hash function selected for present or future security margins. The algorithm identifier byte and reserved attestation bits permit signaling of an alternative hash function selection.

### 5.3 Alternative Carriers and Container Formats

Although the preferred Bitcoin embodiment uses an OP_RETURN data-carrying output, the QD3 record may equivalently be carried by any of: a Taproot annex, a Taproot script-path commitment, an inscription-like metadata record, a sidechain transaction, a rollup commitment, a smart-contract event log, an account-based blockchain transaction calldata field, a layer-two state-channel commitment, an accumulator-root publication, or another publicly timestamped data anchor. The seventy-three-byte preferred layout is a representative compact form and is not limiting; longer forms may be used where larger data-carrying outputs are available, and shorter forms may be used where space is more constrained, provided the essential header, version, algorithm, public-key commitment, signature commitment, and attestation fields are preserved or substituted with equivalent commitments.

### 5.4 Distinction from Commit-Reveal Establishment Protocol

The QD3 record format is distinct from the commit-reveal establishment protocol that may produce its inputs. The commit-reveal establishment protocol establishes initial post-quantum key ownership through a two-transaction process: first committing a thirty-two-byte hash in a first transaction, then revealing the full data including a nonce, a post-quantum public key, and an address in a second transaction after a mandatory security delay. The two-phase approach prevents front-running attacks while proving control over post-quantum keys for existing blockchain addresses. The QD3 record format provides a compact attestation structure that may be used within Post-Quantum Pay transactions, as a single-transaction registration commitment, or as a batch-root commitment, with the same on-chain footprint regardless of which establishment protocol produced the underlying material. The two mechanisms are complementary: the commit-reveal establishment protocol is suited to initial key binding for dormant or never-spent addresses, while the QD3 record format is suited to ongoing transaction-level attestation.

### 6. Confidential Batch Registration

In batch registration, a wallet or service protects multiple addresses or assets with a single timestamped root. Each address-level claim may include an address or blinded address identifier, a salt, a post-quantum public-key hash, a post-quantum signature hash, optional classical control proof, wallet derivation metadata, policy data, and claim context. Each claim is hashed into a leaf:

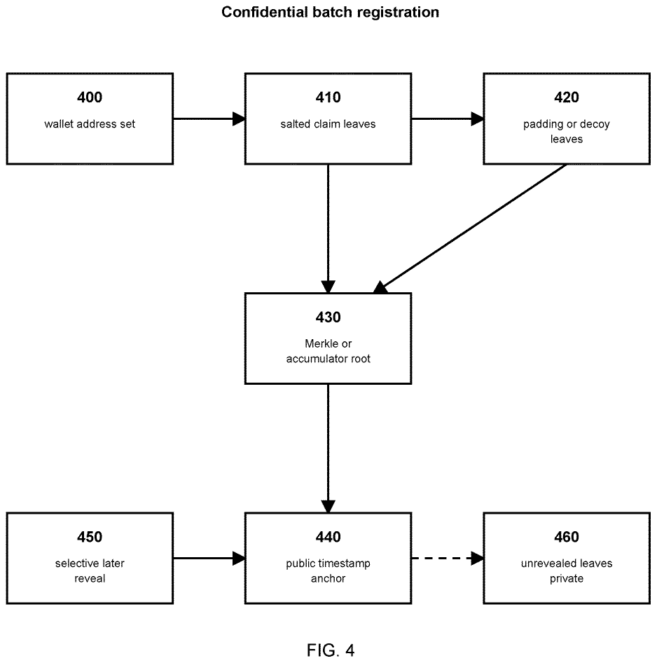

Referring to FIG. 4, a wallet address set 400 is transformed into salted claim leaves 410, optionally together with padding or decoy leaves 420. The leaves form a Merkle or accumulator root 430 that is recorded at a public timestamp anchor 440. Later, a selective reveal 450 may prove inclusion of one address-level claim while unrevealed leaves 460 remain private.
leaf=HASH (batch_domain ∥ leaf_salt ∥ blinded_asset_identifier
post_quantum_public_key_hash ∥ signature_commitment ∥
claim_context ∥ policy_descriptor)

Leaves are combined into a Merkle tree, vector commitment, polynomial commitment, cryptographic accumulator, sparse tree, or other authenticated data structure. Only the root is recorded on-chain. The root may be padded with decoy leaves, dummy leaves, blinded leaves, or fixed-size batches so observers cannot determine how many real addresses are protected.

At reveal time, the claimant discloses only the relevant leaf material and an inclusion proof. Verifiers confirm that the leaf hashes correctly, that the inclusion proof links the leaf to the original root, and that the root was timestamped before the relevant event. Other addresses in the batch remain private.

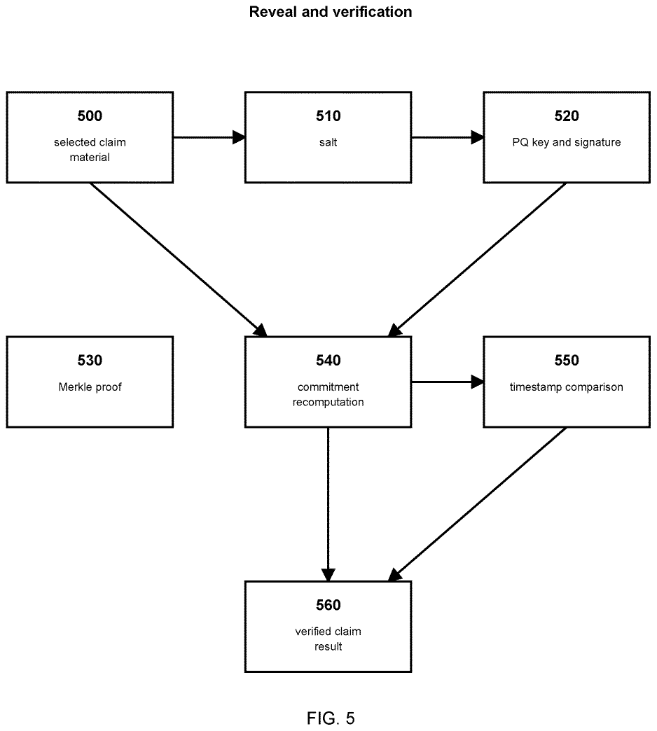

FIG. 5 shows a corresponding reveal and verification embodiment. Selected claim material 500, a salt 510, post-quantum key and signature material 520, and a Merkle proof 530 are supplied to a commitment recomputation process 540. A timestamp comparison 550 confirms temporal priority, producing a verified claim result 560 when the recomputed commitment matches the earlier timestamped record.

### 7. Post-Quantum Public-Key Confidentiality

Publishing full post-quantum public keys before needed may create cost, privacy, or cryptanalytic exposure. Post-quantum public keys may also be large relative to available on-chain data capacity. In preferred embodiments, the system commits to post-quantum public keys using hashes or commitments and reveals the full key only when needed.

At claim time, the verifier hashes the revealed public key and compares it with the earlier commitment. The verifier may also verify a post-quantum signature over a domain-separated claim message. Where algorithm agility is needed, the commitment may include an algorithm identifier, parameter-set identifier, hash-function identifier, or version field.

### 8. Classical Address-Control Proofs

Where safe and applicable, a claimant may include a classical signature proving control of an address at registration time. However, the system does not require a protected P2PKH or P2WPKH UTXO to be spent or an address public key to be revealed. Classical signatures may be omitted for never-spent addresses, replaced by wallet-derived evidence, generated using addresses already exposed, or provided in zero knowledge.

In one embodiment, a wallet signs a domain-separated QD3 claim message from an address whose public key exposure does not worsen the user's risk. In another embodiment, a registrar, exchange, custodian, or trusted service attests that it verified address control without publishing the public key. In another embodiment, a zero-knowledge proof shows that the claimant knows a secret key or wallet seed deriving to the address without revealing intermediate values.

### 9. Zero-Knowledge Ownership Proofs

The system may use zero-knowledge proofs to establish ownership facts without revealing sensitive data. A proof may show that a claimant knows a private key corresponding to an address, that a signature verifies against a public key whose hash matches an address, that a hierarchical deterministic wallet seed and derivation path produce the address, that a committed post-quantum key was derived from a wallet seed, or that a claim leaf is validly formed.

In a hierarchical deterministic wallet embodiment, the claimant proves knowledge of a seed or seed-derived secret which, processed through a derivation path, produces the target address. This proof can remain useful after a quantum attacker derives an address private key from an exposed public key because the attacker does not thereby learn the original wallet seed. The proof may be a ZK-STARK, SNARK, or other proof system. Hash-based or post-quantum-secure proof systems are preferred for post-quantum operation.

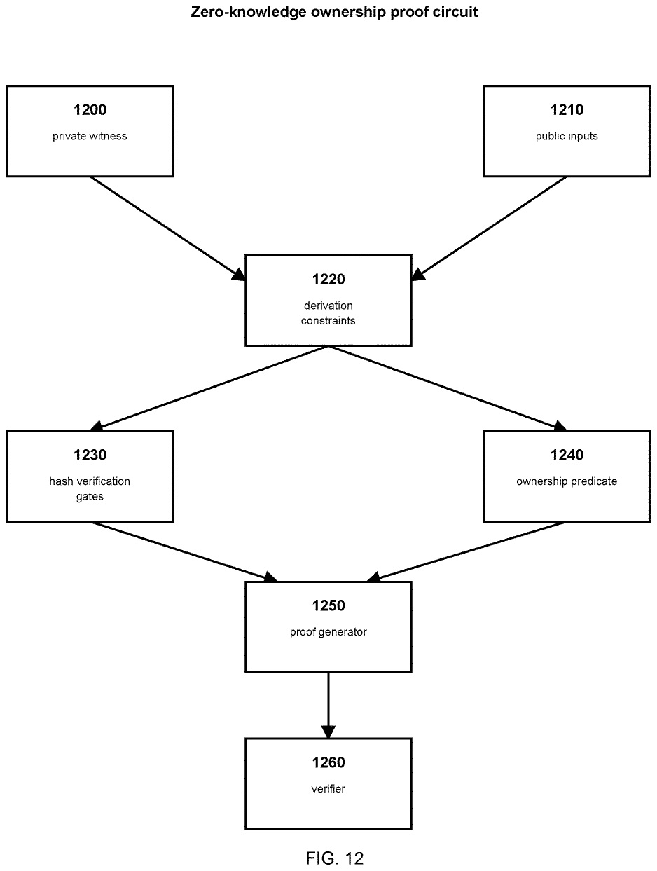

Referring to FIG. 12, a zero-knowledge proof circuit may receive private witness material 1200 and public inputs 1210. Derivation constraints 1220, hash verification gates 1230, and ownership predicate constraints 1240 are evaluated by a proof generator 1250, and the resulting proof is checked by a verifier 1260. These elements provide the circuit-level implementation for proving seed or derivation-path knowledge without revealing the underlying wallet secret.

The system may use BIP-32, BIP-39, BIP-44, BIP-84, BIP-86, SLIP-10, EVM derivation paths, hardware-wallet derivation paths, or other deterministic wallet derivation schemes. Public inputs may include a target address, derivation path, seed commitment, nonce, chain identifier, and policy context. Private witnesses may include a seed, mnemonic-derived seed bytes, chain code, private child key, or other wallet secret.

### 9.1 Critical Insight—Hierarchical Deterministic Seed as Post-Break Ownership Evidence

Existing blockchain ownership proofs rely on a private key proving ownership through a digital signature. When a public key has been exposed on-chain and a quantum adversary derives the private key using Shor's algorithm, the adversary obtains the private key but does not thereby learn the hierarchical-deterministic seed from which the private key was derived. Standard hierarchical-deterministic derivation under BIP-32 from a master seed proceeds through one-way HMAC-SHA512 operations; reversing these operations to recover the seed from a child private key is computationally infeasible for both classical and quantum adversaries within the security margin of the underlying hash function.

Knowledge of the hierarchical-deterministic seed therefore proves legitimate pre-quantum ownership even after a private key has been compromised. The system uses this property to distinguish a legitimate owner, who possesses the original seed, from a quantum adversary, who possesses a derived private key but not the seed.

### 9.2 Preferred Zero-Knowledge Proof Construction

A preferred construction uses a ZK-STARK proof system because ZK-STARK proofs depend only on cryptographic hash functions and contain no elliptic-curve components vulnerable to Shor's algorithm. A representative proof statement is:
“I know a secret S such that derive (S, path) produces the public-key hash for address A.”

A representative private witness comprises one or more of: the hierarchical-deterministic seed S, mnemonic-derived seed bytes, a master chain code, intermediate child private keys, intermediate child chain codes, and ephemeral salts.

A representative public input set comprises one or more of: the target address A, the derivation path P (e.g., m/44′/0′/0′/0/0 for Bitcoin or m/44′/60′/0′/0/0 for Ethereum), a seed commitment C such that C=hash(S), a per-claim nonce, a chain identifier, and a policy descriptor.

The constraint system asserts: (i) application of BIP-32 master-key derivation, master_key=HMAC-SHA512 (“Bitcoin seed”, S); (ii) iterative child-key derivation through hardened or non-hardened derivation steps as specified by the path; (iii) extraction of the public key from the final derived private key; (iv) hashing of the public key to produce an address representation; (v) equality between the derived address and the public input A; and (vi) equality between hash(S) and the seed-commitment public input C.

A SNARK proof system, including Groth16, PLONK, or other elliptic-curve-pairing-based systems, may be used as an alternative for efficiency in pre-quantum deployments where smaller proof sizes and faster verification are desired. SNARK constructions are not post-quantum secure and should be migrated to ZK-STARK or other hash-based proof systems for post-quantum operation. A representative Groth16 implementation can be expressed in approximately one million constraint gates while maintaining one-hundred-twenty-eight-bit pre-quantum security.

### 9.3 Multi-Chain and Universal BIP-39 Compatibility

Because BIP-39 defines a standard mnemonic-to-seed conversion, BIP-32 defines a standard hierarchical derivation, and BIP-44 defines standard derivation paths per coin type, the same proof system applies to any blockchain whose addresses can be derived from a BIP-39 seed through a deterministic derivation path. This includes Bitcoin (m/44′/0′/ . . . ), Ethereum and EVM-compatible chains (m/44′/60′/ . . . ), Litecoin (m/44′/2′/ . . . ), and a substantial number of other compatible chains. A single proof system therefore protects assets across multiple chains, including UTXO-based and account-based blockchains.

### 9.4 On-Chain Embedding and Off-Chain Retrieval for UTXO Chains

For UTXO-based blockchains lacking on-chain proof verification, the proof or a reference to the proof may be embedded in a data-carrying output of a transaction. A representative embedding includes: a protocol identifier (e.g., “ZKHD” or other identifier), a thirty-two-byte hash of the proof, and a retrieval reference to the full proof, including but not limited to an IPFS content identifier, an Arweave identifier, or an inline encoding where the proof size permits. A receiving wallet, exchange, or service may retrieve the proof, verify it off-chain, and apply a policy to the received funds, including accept, escrow, return to sender, forward to escrow service, or reject.

### 9.5 On-Chain Verification for Account-Based Chains

For account-based blockchains supporting smart-contract verification, the proof may be supplied as an argument to a proof-gated transfer function that verifies the proof on-chain before executing the transfer. The smart contract reverts the transfer if proof verification fails. The smart contract may also store, per address, a hash commitment of a hierarchical-deterministic seed and a per-address nonce that increments after each successful proof-gated transfer to prevent replay of previously valid proofs.

### 9.6 Multi-Chain Verification and Quantum-Attack Resistance

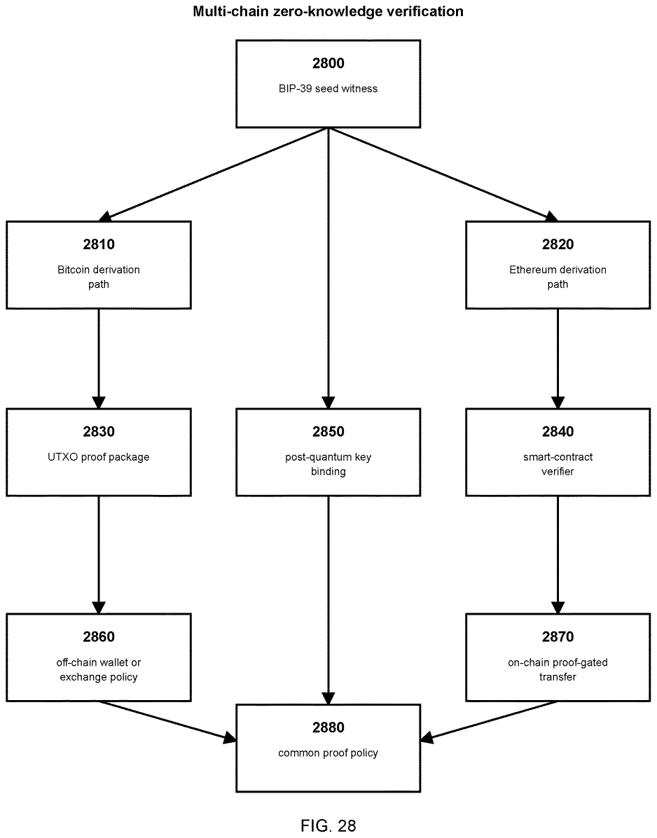

As shown in FIG. 28, a common zero-knowledge ownership proof architecture may serve both UTXO chains and account-based chains. A BIP-39 seed witness 2800 may be processed through a Bitcoin derivation path 2810 to produce a UTXO proof package 2830 verified off-chain by a wallet, exchange, custodian, recovery service, bridge, or arbitrator without requiring a Bitcoin consensus change. The same BIP-39 seed witness 2800 may be processed through an Ethereum derivation path 2820 to produce an account-based proof verified by a smart-contract verifier 2840 before an on-chain proof-gated transfer 2870 executes. The proof architecture may also bind post-quantum key binding 2850, an off-chain wallet or exchange policy 2860, and a common proof policy 2880 so that different chains can recognize a consistent ownership and recovery claim while applying chain-specific verification mechanisms.

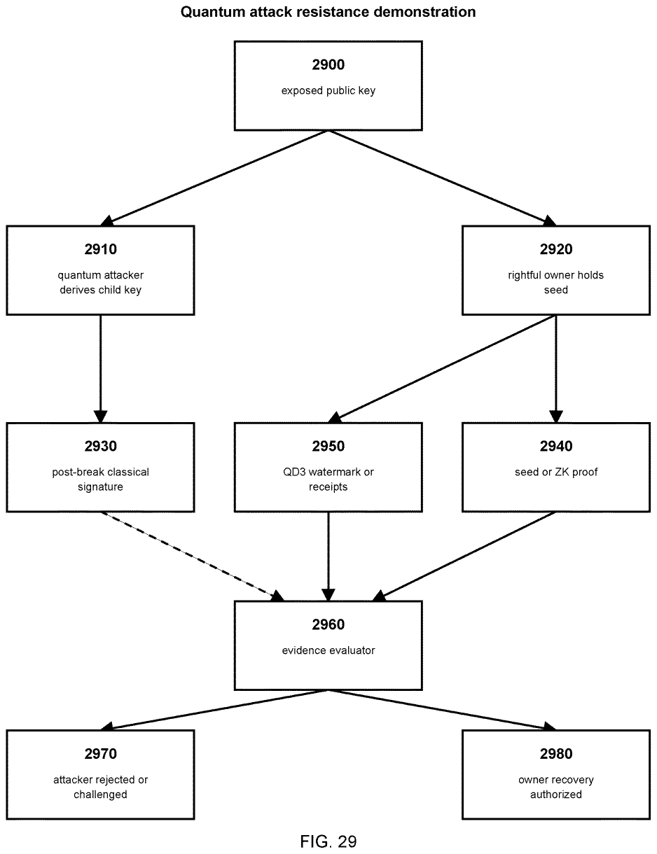

As shown in FIG. 29, the system distinguishes a quantum attacker who derives a classical child key 2910 from an exposed public key 2900 from a rightful owner who holds a seed 2920. A post-break classical signature 2930 may be treated as weak or challengeable evidence because both the rightful owner and a quantum attacker may produce it. By contrast, a seed or zero-knowledge proof 2940, a QD3 watermark or receipts 2950, and other pre-compromise evidence may be weighted more strongly by an evidence evaluator 2960. The evaluator 2960 may reject or challenge an attacker claim 2970 while authorizing owner recovery 2980 for a claimant who supplies superior asymmetric evidence.

### 10. QSAVE Protective Custody

QSAVE uses ownership evidence and risk classification to preserve assets at risk of quantum theft. A QSAVE system may include:
a blockchain scanner identifying exposed public keys, reused addresses, P2PK outputs, Taproot exposure, multisignature scripts, dormant assets, inherited-asset patterns, high-value outputs, or vulnerable channel states;
a threat monitor using quantum-computing benchmarks, demonstrated attacks, expert thresholds, market signals, government migration deadlines, or protocol activation dates;
a QD3 indexer that maps public commitments, confidential roots, and reveal events;
a custody address generator producing multisignature, threshold-signature, script-based, smart-contract, vault, or post-quantum-controlled addresses;
a custodian coordination module requiring m-of-n approval across independent entities;
an audit module recording custody actions, notices, proofs, and recovery decisions;
a recovery portal accepting claims and evidence.

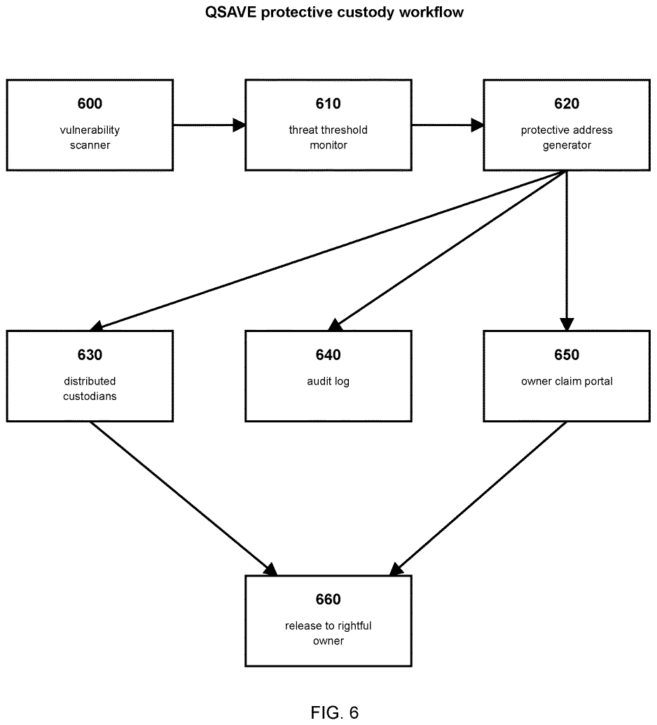

Referring to FIG. 6, a vulnerability scanner 600 may identify exposed or otherwise vulnerable assets, and a threat-threshold monitor 610 may determine when protective action is warranted. A protective address generator 620 creates custody destinations controlled by distributed custodians 630. An audit log 640 records the custody event and later claim processing through an owner claim portal 650, which may ultimately authorize release to a rightful owner 660.

Protective custody may be used in different modes. In opt-in mode, a user pre-authorizes a future protective action through a QD3 record, policy descriptor, delegate signature, recovery script, or smart contract. In supervised mode, an exchange, trustee, estate fiduciary, court, DAO, or custodian acts under an applicable authority. In emergency or lost-property mode, a legal or governance framework may permit preservation of assets that would otherwise be stolen by quantum attackers. The specification describes technical mechanisms and does not determine legal authorization in any jurisdiction.

In one embodiment, after a quantum-threat threshold is met and an exposed public key is classified as vulnerable, a protective actor moves funds to a protective custody address. The protective custody address requires signatures from distributed custodians and may also require an original owner signature, a post-quantum claimant signature, a QD3 reveal, a zero-knowledge proof, an arbitration order, a time lock, or a threshold recovery process. No single custodian can unilaterally transfer assets for personal benefit.

### 10.1 Threat-Phase Operating Model

In some embodiments, the QSAVE system operates according to a multi-phase threat model in which the operating posture changes as the underlying quantum threat escalates. The phases comprise:
a peace phase, in which the system prepares by identifying vulnerable assets, accepting opt-in QD3 commitments, performing user education, and generating distributed custodian infrastructure but takes no involuntary protective custody actions;
a warning phase, activated upon credible quantum-threat indicators including but not limited to NIST quantum-computing benchmarks and announcements, demonstrated quantum attacks on test networks, expert consensus from recognized authorities, market-based prediction signals, government migration deadlines, or protocol activation dates, in which the system intensifies vulnerability scanning and accelerates user notifications;
a crisis phase, activated upon a quantum-threat threshold determined by combinations of the foregoing indicators, in which the system implements full protective custody actions on classified vulnerable assets;
a recovery phase, in which the system processes owner claims and authorizes systematic returns of protected funds to legitimate claimants.

The phase-activation logic uses combinations of the foregoing indicators with weighted thresholds to prevent both premature and delayed activation, and to require multiple independent indicators before transitioning between phases.

### 10.1A Quantum Threat Projection and Complete Protection Journey

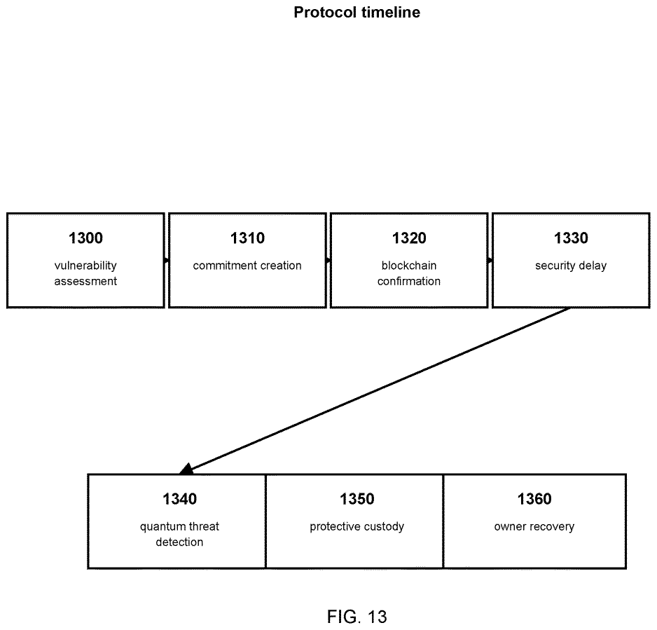

As shown in FIG. 13, a protocol timeline may begin with vulnerability assessment 1300 and commitment creation 1310. A blockchain confirmation 1320 may establish a timestamped record, followed by a security delay 1330 before quantum threat detection 1340. If a trigger condition is met, protective custody 1350 and owner recovery 1360 may follow. The FIG. 13 timeline therefore links pre-event registration to later recovery, rather than treating registration as an isolated event.

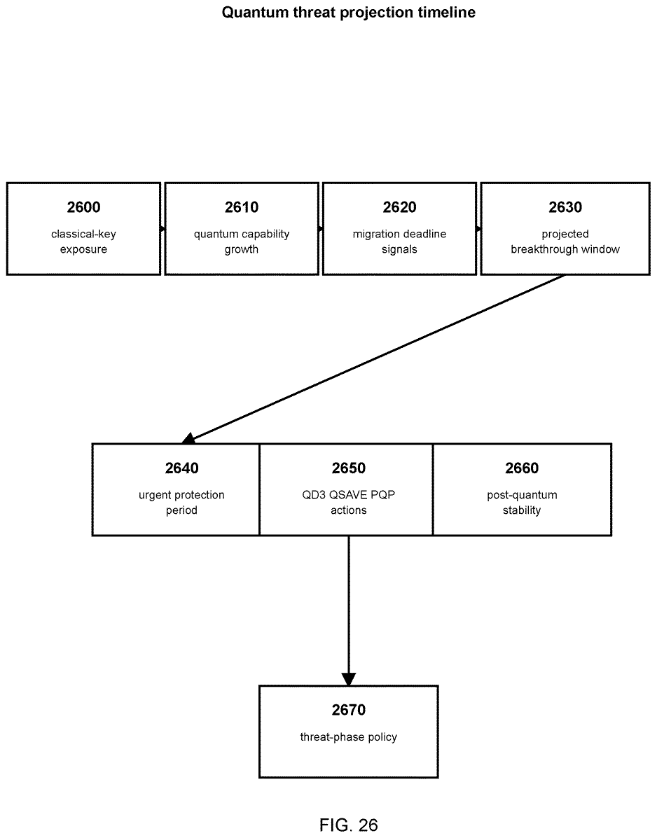

As shown in FIG. 26, a threat projection timeline may track classical-key exposure 2600, quantum capability growth 2610, migration deadline signals 2620, a projected breakthrough window 2630, an urgent protection period 2640, QD3/QSAVE/PQP actions 2650, post-quantum stability 2660, and threat-phase policy 2670. The timeline may be used by QSAVE, QD3 verifiers, recovery ledgers, wallets, exchanges, custodians, bridge operators, stable coin issuers, and governance bodies to determine when to warn users, accelerate QD3 registration, require post-quantum authorization, activate protective custody, or enforce migration policies. The timeline is not limited to fixed calendar dates; it may be driven by measured quantum-computing capability, cryptanalytic demonstrations, government or standards-body deadlines, blockchain governance decisions, market signals, or expert-threshold events.

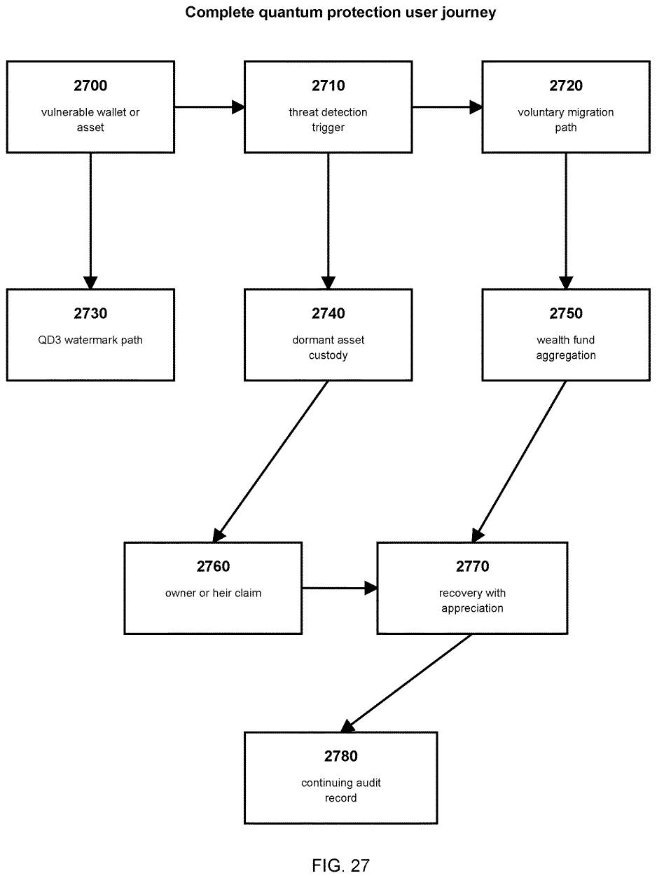

As shown in FIG. 27, a complete protection journey may begin with a vulnerable wallet or asset 2700. A threat-detection trigger 2710 may route an active owner to a voluntary migration path 2720, a QD3 watermark path 2730, or PQP transaction construction. A dormant or unavailable owner may instead be routed through dormant asset custody 2740. Protected assets may optionally enter wealth fund aggregation 2750 while preserving owner claims. An owner or heir claim 2760 may later result in recovery with appreciation 2770, with a continuing audit record 2780 preserving the history of protection, custody, and recovery steps.

### 10.2 Dynamic Custody Thresholds

In some embodiments, the m-of-n threshold parameters of the protective custody address are dynamically adjusted based on the threat phase or other detected risk signals. For example, a custody address operating under a five-of-seven threshold during the peace phase may transition to a seven-of-nine threshold during the warning phase and a nine-of-eleven threshold during the crisis phase. AI-assisted monitoring may inform these adjustments based on detected attack patterns, custody-key compromise indicators, governance signals, or performance metrics.

### 10.3 FROST and Other Threshold Signature Implementations

In some embodiments, the protective custody address uses a Flexible Round-Optimized Schnorr Threshold (FROST) signature scheme to enable threshold signatures with reduced communication overhead and aggregated single-signature on-chain footprint. Other threshold-signature schemes may be used as alternatives, including BLS threshold signatures, threshold ECDSA constructions, threshold ML-DSA constructions, or any other m-of-n cryptographic signature scheme suitable for the underlying blockchain. The custody address may also use a Bitcoin-script multisignature output, a Pay-to-Script-Hash multisignature output, a Taproot multisignature output, an account-based smart-contract multisignature wallet, a vault contract, or a hardware-security-module-backed signing infrastructure.

### 10.4 Geographic and Jurisdictional Distribution

In preferred embodiments, the custodian set is distributed across multiple geographic regions, multiple legal jurisdictions, multiple time zones, multiple hardware-security-module providers, and multiple governance bodies, to mitigate the risk that any single regional event, regulatory action, hardware vulnerability, or governance failure could compromise the custody system. Custodian-key rotation schedules, role-based access controls, emergency-succession plans, and continuous-availability monitoring may further reduce single-point-of-failure risks.

### 10.5 Inheritance-Pattern Detection and Auntie-Alice Protection

In some embodiments, the QSAVE system identifies likely inherited assets through detection of patterns including but not limited to: long dormancy periods consistent with original-owner death or lost access; address-discovery events triggered by physical recovery of cold storage media after long inactivity; transactions from heir-controlled custodial services consistent with probate distribution; and inheritance-probability scoring derived from address activity patterns and external attestations. Detected likely-inherited assets receive enhanced protection priorities, including extended grace periods before involuntary protective action, streamlined claim processes for heirs presenting probate or trust documentation, and reduced stake requirements for documented heirs.

### 11. Recovery and Claim Resolution

The recovery framework accounts for the fact that classical private keys may become unreliable evidence after quantum compromise. A claimant may submit one or more of:
a QD3 reveal including salt, address identifier, post-quantum public key, post-quantum signature material, and policy context;
a Merkle or accumulator proof linking an address-level claim to a timestamped batch root;
a post-quantum signature by a committed post-quantum key;
a zero-knowledge proof of seed knowledge or derivation-path control;
a pre-break classical signature or time-stamped message;
wallet backups, wallet.dat fragments, seed phrase portions, hardware-wallet records, transaction records, exchange records, KYC records, purchase records, estate records, trust documents, probate documents, social attestations, or communications;
a stake or bond deterring fraudulent claims;
encrypted evidence for blind arbitration.

The framework may score evidence based on timestamp priority, cryptographic strength, consistency with blockchain history, uniqueness, corroboration, challenge outcomes, and fraud risk. A challenge period may allow competing claimants to submit superior evidence. A blind arbitration process may protect claimant privacy by allowing encrypted evidence submission and distributing review among selected arbitrators. Fraudulent claims may be penalized by slashing a stake or denying future claims. Successful claims may result in transfer of principal, appreciation, yield, or replacement assets to a quantum-safe address.

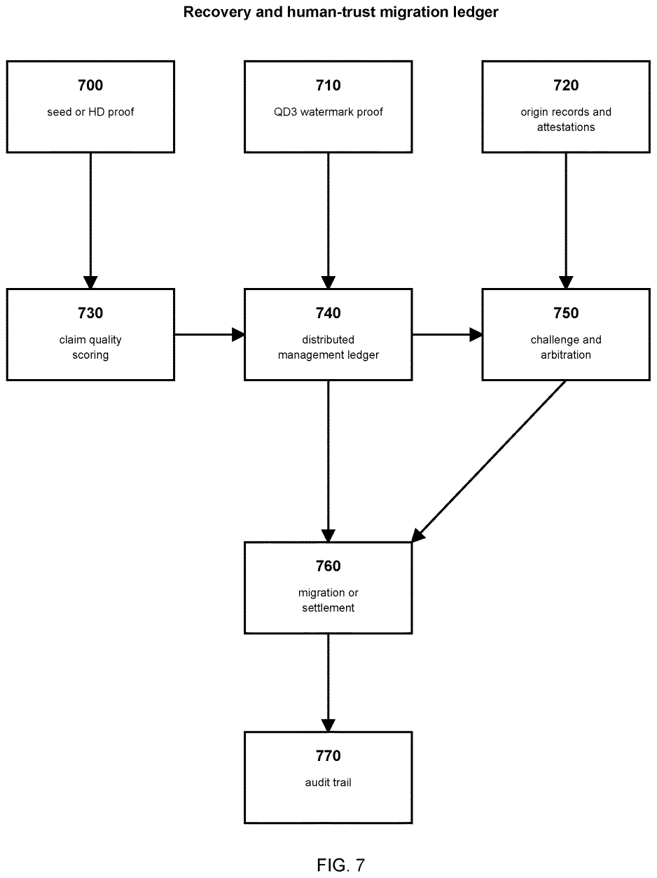

Referring to FIG. 7, recovery may combine a seed or HD proof 700, QD3 watermark proof 710, and origin records or attestations 720. Claim quality scoring 730 feeds a distributed management ledger 740, which supports challenge and arbitration 750 before migration or settlement 760. An audit trail 770 records the sequence of recovery decisions. FIG. 23 further illustrates how the recovery evaluator 2300 compares evidence classes 2310, 2320, 2330, and 2340 with blockchain history 2350 and a recovery policy 2360.

### 11.1 Three-Tier Confidential Evidence Packets

In a preferred embodiment, the recovery framework processes confidential evidence packets organized into three tiers. Each packet is identified on-chain only by a hash commitment, with the cleartext contents remaining confidential to an authorized oracle set. An optional self-chosen alias may provide audit transparency without identity revelation. The evidence tiers comprise:
Tier 1: cryptographic proofs with verifiable pre-break timestamps, including but not limited to digital signatures embedded in pre-quantum-era blocks, notarized pre-break documents, pre-break public-key publications, and timestamped commitments referencing chains of derivation;
Tier 2: third-party records, including but not limited to centralized exchange transaction logs, bankruptcy administrator filings, court probate rulings, trustee statements, custodian records, and identity-verification records held by regulated entities;
Tier 3: supporting materials, including but not limited to sworn affidavits, chain-of-inheritance documentation, contemporaneous media coverage, witness declarations, and corroborating communications.

### 11.2 Submission, Staking, and Two-Phase Verification

The framework supports multiple staking modes. A standard submission requires the claimant to post a stake that is slashed for forgery or fabrication. A zero-stake submission may be permitted for incontestable Tier 1 proofs. A third-party bonding mode permits insurance-like services to front stakes for smaller claimants in exchange for a fee or a share of recovered funds. Verification proceeds in two phases. In a first phase, an open lint gateway performs preliminary validation through public application-programming interfaces, including but not limited to file-format verification, timestamp-syntax checking, and header-consistency validation. In a second phase, a federated oracle network performs deep evaluation, including but not limited to packet decryption, timestamp verification, cross-reference checking against blockchain history and external records, and assignment of a Claim Quality Score. The federated oracle network's evaluation criteria may be intentionally undisclosed to prevent strategic gaming of the scoring system.

### 11.3 Partial Distribution, Challenge Window, Reserve Decay, and Final Settlement

Following oracle review, the framework may release a fraction α of the disputed funds proportional to the assigned Claim Quality Score, with the remaining fraction (1−α) retained in reserve. A representative value of a is approximately 0.80, releasing eighty percent of the disputed funds for an unchallenged top-scoring claim. A challenge window of representative duration of approximately twelve months permits competing claimants to submit superior evidence; successful challenges trigger clawback of partial distributions and redistribution to the superior claimant. Following expiration of the challenge window without successful challenge, a reserve-decay mechanism gradually releases the remaining reserve to the recognized claimant over a representative duration of approximately three years. Final settlement marks the address as fully adjudicated when reserves reach zero. The above durations and proportions are representative and may be adjusted by governance, policy, contract, or arbitration without departing from the framework.

### 11.4 Documentary Wallet Recovery State Machine

In some embodiments, the recovery framework includes a documentary wallet recovery state machine for processing claims supported by documentary rather than cryptographic evidence. The state machine comprises:

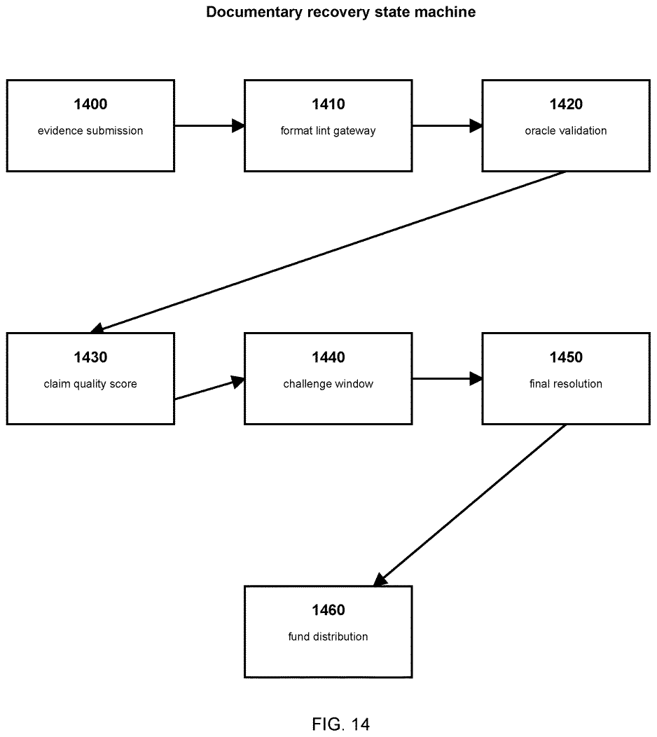

Referring to FIG. 14, the documentary recovery state machine may begin with evidence submission 1400, pass through a format lint gateway 1410 and oracle validation 1420, assign a claim quality score 1430, open a challenge window 1440, reach final resolution 1450, and execute fund distribution 1460.
evidence submission states accepting wallet backups, key-derivation-information records, mnemonic-phrase fragments, hardware-wallet receipts, exchange purchase records, custodian records, identity-verification records, death certificates, court orders, trust documents, probate documents, and transaction histories;
validation stages verifying document authenticity through oracle networks and applying arbitration criteria including evidence consistency with blockchain history, temporal priority of claim submission, absence of superior competing claims, and overall credibility assessment;
arbitration triggers activating when evidence meets threshold requirements, with a refundable stake requirement of representative magnitude (e.g., approximately 0.01 BTC) to deter frivolous claims;
competing-claim handling managing simultaneous recovery attempts through a representative thirty-day challenge window;
final-resolution states determining legitimate ownership with two outcomes—successful resolution returns the stake minus fees and authorizes recovery, while unsuccessful resolution forfeits the stake with an option to resubmit upon presentation of additional evidence; and
fund-distribution mechanisms executing recovery transfers with appropriate time delays for appeals, optionally accompanied by quantum-safe key binding for the recovered address.

### 11.5 Open Claim System and Adversarial Design

In a preferred embodiment, the recovery framework intentionally permits any party to file a claim against any blockchain address, including addresses the filer does not control. This open design is required because protocol-level prevention of false claims would necessitate revealing public-key material that the system seeks to protect, because legitimate claimants such as heirs and recovery services may not yet possess private keys when filing protective claims, and because censorship resistance is preserved through permissionless participation. The adversarial design is supported by the staking, oracle review, scoring, challenge-window, reserve-decay, and slashing mechanisms described above, which collectively deter fraudulent claims while protecting legitimate claimants.

### 11.6 Distributed Human-Trust Migration Ledger

In some embodiments, recovery, migration, protective custody, reserve allocation, and settlement actions are coordinated by a distributed management ledger. The ledger may be implemented as a blockchain, rollup, sidechain, transparency log, notarized database, federated ledger, public-commitment database, decentralized autonomous organization ledger, or other append-only or publicly auditable record. The distributed management ledger records migration candidates, claim submissions, evidence hashes, QD3 references, challenge periods, custodian actions, votes, legal attestations, auditor reports, reserve allocations, releases, settlements, and later corrections.

The ledger separates technical cryptographic evidence from human-trust determinations. A registry layer records affected assets and process status. An evidence layer links seed proofs, watermark proofs, transaction-origin records, documentary records, court or probate documents, exchange attestations, custodian attestations, and identity attestations to the registry. A governance layer receives attestations or votes from independent custodians, exchanges, miners, trustees, courts, arbitrators, auditors, community representatives, affected holders, or other validators. A consensus or voting layer determines whether a migration, release, reserve allocation, freeze, reissue, or recovery action should proceed. An audit layer publishes a human-readable and machine-verifiable history showing that the action resulted from a distributed human-trust process rather than unilateral action by a single custodian, issuer, bridge operator, exchange, or software provider.

The distributed management ledger 740 of FIG. 7 and the audit trail 770 shown in the same figure may therefore operate together with the QSAVE audit log 640 of FIG. 6 and the continuing audit record 2780 of FIG. 27 to provide a machine-verifiable and human-readable history of the migration process.

### 12. Inheritance and Dormant Assets

The system supports dormant or inherited assets whose owners cannot act before a quantum event. A user may create a QD3 record during life without revealing the address or wallet structure. Estate documents, heirs, trustees, or recovery agents may later use the QD3 reveal and additional documentation to prove a claim. Where no QD3 record exists, QSAVE may rely on alternative evidence and legal frameworks. Grace periods, notice mechanisms, challenge windows, and partial distributions may reduce false transfers while preserving assets from quantum theft.

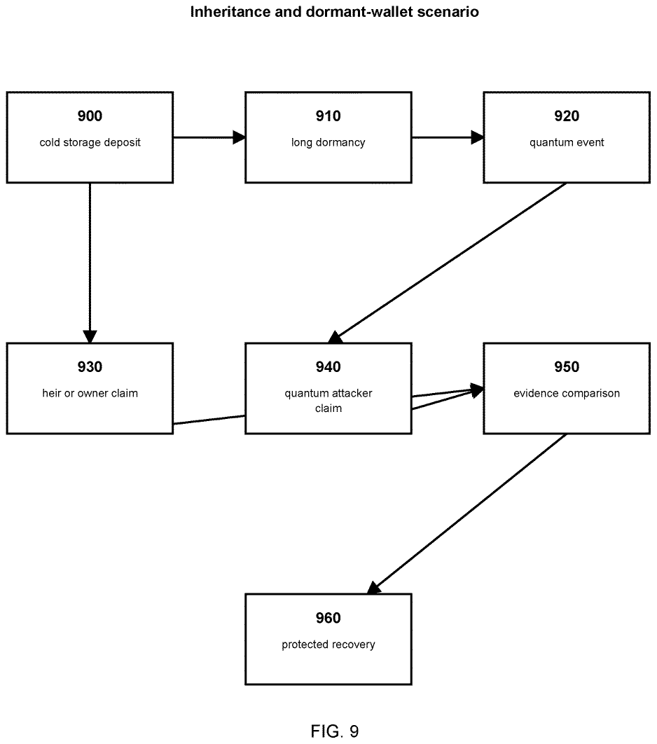

Referring to FIG. 9, an asset may originate as a cold-storage deposit 900 and remain inactive during a long dormancy period 910 before a quantum event 920. After the event, an heir or owner claim 930 and a quantum attacker claim 940 may both be presented. Evidence comparison 950 evaluates the competing claims and may authorize protected recovery 960 for the superior claimant.

### 13. Post-Quantum Pay

PQP is a wallet-layer transaction-construction process designed to prevent funds from remaining under exposed classical keys after spending. When a user initiates a transaction from an address that will reveal a public key or has already revealed a public key, the wallet gathers all UTXOs or controllable funds associated with the exposed address or policy group. It constructs a transaction that pays intended recipients and directs all change to quantum-safe outputs. No change is returned to the exposed address.

The transaction may include a QD3 attestation or commitment. A change output may be sized to support child-pays-for-parent acceleration. Fee-management logic may avoid confirmation delays during a quantum vulnerability window. The wallet may disable or manage replacement behavior depending on threat assumptions. If an address type cannot be fully protected without protocol changes, the wallet may warn the user and recommend immediate migration.

PQP may be implemented in user wallets, exchange withdrawal systems, custodial systems, merchant processors, Lightning channel closures, DeFi withdrawal processes, or bridge exits. PQP may operate with existing blockchain consensus rules while signaling post-quantum claim material to receiving wallets, exchanges, or verifiers.

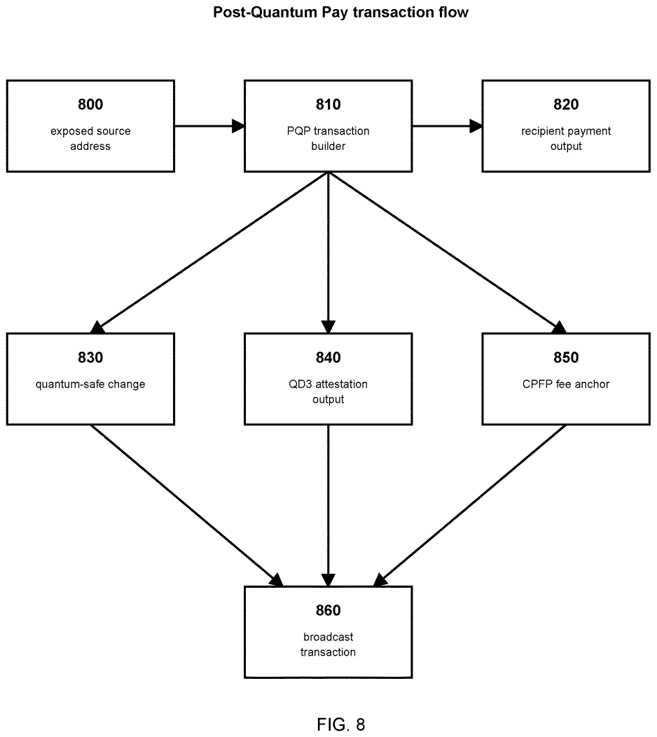

Referring to FIG. 8, an exposed source address 800 is handled by a PQP transaction builder 810. The builder creates a recipient payment output 820, quantum-safe change 830, an optional QD3 attestation output 840, a CPFP fee anchor 850, and a broadcast transaction 860. These elements show how the wallet-level transaction flow prevents return of funds to the exposed source address 800.

### 13.1 Three-Layer Protection Model

The PQP transaction construction process implements protection in three complementary layers:
Layer 1: Atomic Sweep at Source. The wallet identifies all unspent transaction outputs at the exposed sending address, computes the total controllable balance, and constructs a single atomic transaction that simultaneously: (a) pays the intended recipient at any compatible address type; (b) directs all change to one or more newly-generated quantum-safe addresses with at least a minimum value sufficient to support child-pays-for-parent fee acceleration (e.g., approximately 0.0001 BTC); and (c) embeds a QD3 attestation in a data-carrying output. The atomic structure ensures that the transaction either completes entirely or fails entirely, preventing partial spends that could leave residual funds under the exposed key.
Layer 2: Tamper-Resistant Transaction Construction. The atomic sweep structure cryptographically commits to all inputs and outputs through transaction signing, such that any modification to inputs, outputs, addresses, amounts, or sequence numbers invalidates the signature. The transaction is therefore safe to broadcast to a public mempool even when quantum adversaries are observing. An attacker cannot add outputs, modify recipient addresses, redirect funds, or otherwise alter the protective sweep without invalidating the signature.
Layer 3: Replacement-Disabled with Child-Pays-For-Parent Protection. The transaction is signed with a sequence number that disables Replace-By-Fee (e.g., 0xFFFFFFFF), preventing an attacker who has derived the sender's private key from broadcasting a higher-fee replacement that redirects funds. Fee acceleration is preserved through the Child-Pays-For-Parent mechanism: the quantum-safe change output, sized at or above the minimum CPFP value, can be spent in a subsequent child transaction at a higher fee rate, pulling both parent and child into the next available block. In transactions where no change output is generated (e.g., where the total balance equals the payment plus fees), a service-fee output may stand in as the CPFP anchor, in which case the service-fee output is mandatory. CPFP child transactions used to accelerate stuck PQP parents must themselves follow the PQP construction pattern, creating recursive protection in which each successive transaction continues to sweep funds away from any newly-exposed addresses.

### 13.2 Core PQP Transaction Flow

A representative PQP transaction flow comprises:
1. The user initiates a standard payment from a sending address using a wallet, exchange withdrawal interface, custodial interface, merchant processor, channel-closure routine, or bridge-exit routine.
2. A PQP module intercepts the transaction before broadcast.
3. The PQP module enumerates all unspent transaction outputs controllable by the sending address or by an associated policy group.
4. The PQP module generates one or more fresh quantum-safe addresses, including but not limited to Bech32m-encoded addresses with mainnet prefix “qk1” or testnet prefix “tqk1”.
5. The PQP module constructs an atomic sweep transaction containing: at least one input drawn from the sending address; an output paying the intended recipient at the originally-requested amount; a change output directing the remaining balance, after fees, to a newly-generated quantum-safe address with at least the CPFP minimum value; an OP_RETURN output containing a QD3 attestation; and optionally one or more service-fee outputs and additional payment outputs for batch transactions.
6. The PQP module signs the transaction with sequence numbers configured to disable Replace-By-Fee.
7. The PQP module broadcasts the signed transaction to the network through a public mempool, a private mempool, a direct-to-miner submission channel, or another broadcast mechanism.

The protocol remains quantum-safe even where quantum adversaries observe the broadcast, because the signature commits to all inputs and outputs, RBF is disabled, and CPFP is available to ensure timely confirmation if the initial fee proves insufficient.

### 13.3 Output Configurations and Modes

The PQP transaction may operate in multiple output configurations, including but not limited to:
a minimal mode comprising two outputs (recipient payment plus quantum-safe change), suitable for users handling their own quantum key management;
a standard mode comprising three outputs (recipient payment, quantum-safe change, and QD3 OP_RETURN attestation);
a commercial mode comprising four outputs adding a service-fee output for sustainable PQP-provider business models; and
a batch mode comprising additional payment outputs for efficient multi-party payments while maintaining quantum safety.

### 13.4 Public-Mempool Reliability and Recursive CPFP

In some embodiments, the PQP transaction is broadcast to a public mempool to take advantage of the full distributed mining hashrate, ensuring persistence across block reorganizations. This contrasts with private-mempool services that route transactions to a single mining provider; private-mempool transactions in blocks that lose mining races may have their data become public without confirmation, exposing quantum vulnerability without achieving protection. A PQP transaction broadcast to the public mempool remains available to all miners and can be accelerated through CPFP as needed. The CPFP child transaction must itself follow the PQP construction pattern, creating recursive protection where each transaction continues to sweep funds away from any newly-exposed addresses.

### 13.5 Address-Type Warnings

For address types whose public keys are exposed at funding rather than at spending, including Bitcoin Pay-to-Public-Key (P2PK) outputs and Bitcoin Taproot outputs (e.g., bech32m-encoded addresses with prefix “bc1p”), the PQP module may detect such inputs in a constructed transaction and provide warnings indicating that the address type cannot be fully protected without protocol changes. The warnings may include user-facing notifications recommending immediate migration of funds away from such address types and indicating that any spend will permanently expose the public key. The PQP module may decline to continue, may proceed with explicit user acknowledgment, or may automatically route funds through a recovery or migration path.

### 13.6 Post-Quantum Ownership Verification Through Pre-Quantum QD3 Markers

In some embodiments, a QD3 attestation embedded in a transaction during the pre-quantum era serves as cryptographic proof of pre-quantum wallet ownership. After a quantum-transition event, a user may present an extended public key or extended private key from a hierarchical-deterministic wallet to demonstrate that one or more addresses within the wallet's derivation paths contain QD3 attestations created before the quantum-transition event. This provides ownership evidence that does not depend on subsequently-derivable elliptic-curve private keys. The proof mechanism operates as follows: (a) during the pre-quantum era, the user records at least one QD3-marked transaction within the wallet's derivation path; (b) the QD3 creation process does not require revealing the private key to a service provider, because transactions can be constructed for hardware-wallet signing through a Partially Signed Bitcoin Transaction or analogous mechanism; (c) following the quantum-transition event, the user demonstrates wallet ownership by showing that the extended public key or extended private key derives addresses containing pre-quantum QD3 markers; (d) the blockchain timestamp on the QD3 attestation establishes pre-quantum control of the wallet; and (e) the user need not have used PQP-specific wallet software to create such markers, because they can be created through any compatible signing service.

### 14. Lightning, Channel, and Layer-2 Protection

Payment channels and layer-2 systems may include pre-signed states, exposed keys, watchtowers, and delayed settlement rules. A QSAVE or PQP module may monitor channel funding outputs and closure transactions. Cooperative closures may be reconstructed to sweep funds to quantum-safe outputs with QD3 attestations. Non-cooperative or emergency closures may use watchtower templates that preserve quantum-safe routing of funds. State migration may preserve routing functionality while replacing vulnerable keys.

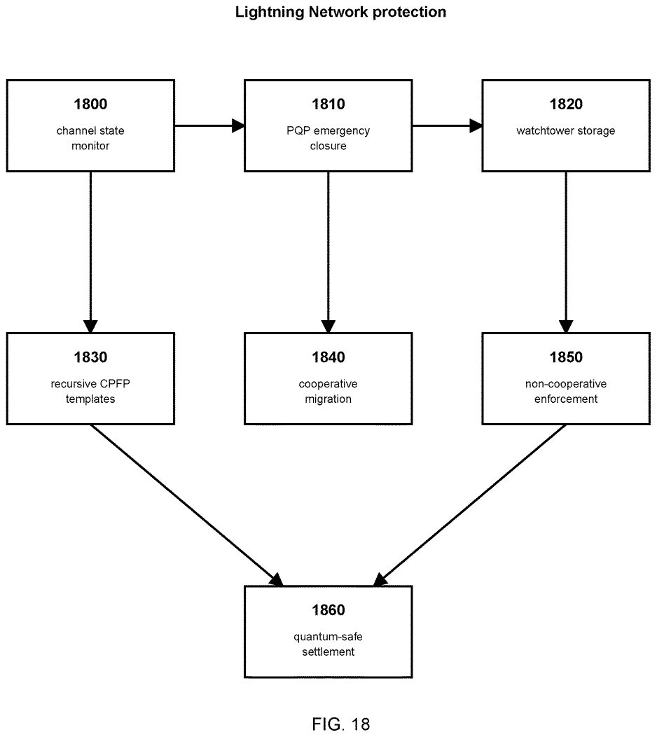

Referring to FIG. 18, a channel state monitor 1800 may trigger a PQP emergency closure 1810, with watchtower storage 1820 preserving pre-signed or template closure transactions. Recursive CPFP templates 1830, cooperative migration 1840, and non-cooperative enforcement 1850 may each route value to quantum-safe settlement 1860.

### 14.1 PQP-Compliant Channel Closures

In some embodiments, all Lightning Network channel-closing transactions are constructed in compliance with the PQP transaction-construction process described above. PQP-compliant channel closures comprise: a complete sweep of channel funds to one or more quantum-safe addresses, with no outputs returning to channel addresses; a QD3 attestation in an OP_RETURN output marking the closure as quantum-protected; one or more change outputs sized at or above the CPFP minimum value to support fee acceleration; sequence numbers configured to disable Replace-By-Fee; and recursive PQP-compliant CPFP fee acceleration where required.

### 14.2 Pre-Signed PQP Closures and Watchtower Storage

In some embodiments, during channel setup, both channel parties pre-sign emergency PQP-compliant closing transactions that sweep all channel funds to their respective quantum-safe addresses. The pre-signed closing transactions are stored in watchtowers configured to broadcast the closures upon detection of channel-closure conditions or quantum-threat triggers. The watchtower templates include recursive CPFP templates such that subsequent fee-acceleration transactions also follow the PQP construction pattern, preserving quantum-safe routing of funds even during forced closures.

### 14.3 Cooperative and Non-Cooperative Closures

In a cooperative-closure embodiment, both parties construct a PQP-compliant closing transaction at the time of intended channel closure, sweeping all funds to fresh quantum-safe addresses. In a non-cooperative-closure embodiment, the unilateral or watchtower-driven closing transaction is constructed in advance to comply with PQP, ensuring that even forced or emergency closures preserve quantum safety.

### 15. DeFi, Token, and Smart-Contract Protection

For account-based blockchains and token systems, the system may use proof-gated transfer functions, quantum locks, vault layers, wrapped token layers, or recovery contracts. A smart contract may store a commitment to a wallet seed, post-quantum public key, QD3 root, or claim policy. Standard transfers may be blocked when a quantum lock is active. A proof-gated transfer function may require a zero-knowledge proof or post-quantum signature before moving assets.

In some embodiments, the account-based architecture protects control points of EVM-compatible contracts rather than only end-user token balances. A control point may include an externally owned account authority, contract-account authority, account-abstraction validation function, ERC-1271 signature-validation function, token-transfer authority, token-approval authority, mint authority, burn authority, redemption authority, reserve authority, bridge authority, upgrade authority, administrative role, oracle-update authority, governance-execution authority, emergency-pause authority, or recovery authority. A post-quantum contract system, including embodiments referred to as Eth VaultPQ, ERC20PQ, or similar, may require post-quantum signatures, zero-knowledge proofs of hierarchical-deterministic seed knowledge, QD3 commitment reveals, threshold authorization, hardware-wallet attestations, ERC-1271-compatible validation results, account-abstraction validation results, Merkle proofs, accumulator proofs, or contract-policy proofs before such control points execute protected operations.

In some embodiments, an ERC-1271-compatible validator provides a standard contract-signature interface for post-quantum or proof-gated authorization. An EOA, contract account, account-abstraction wallet, token contract, vault contract, bridge contract, stable coin contract, oracle contract, governance contract, upgradeable proxy, or administrative controller may delegate validation to the ERC-1271-compatible validator or to an equivalent smart-contract verifier. In this way, existing EVM applications can replace or supplement classical owner-key control with post-quantum, seed-verified, QD3-backed, or policy-gated control without redesigning every application-specific contract. A post-quantum stable coin, including an implementation referred to as USDPQ, is one example of the broader post-quantum EVM contract-control architecture.

For DeFi positions, a protection module may identify liquidity-provider tokens, lending positions, staking positions, governance positions, bridges, and cross-chain assets. It may coordinate atomic migration, vault wrapping, claim evidence, and recovery of complex positions without forced liquidation where possible.

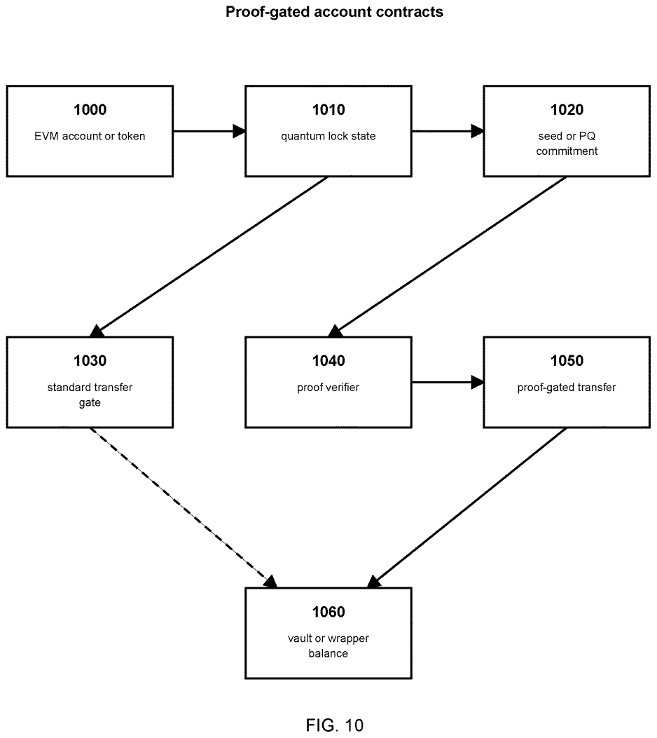

Referring to FIG. 10, an EVM account or token 1000 may be associated with a quantum-lock state 1010 and a seed or post-quantum commitment 1020. A standard transfer gate 1030 may be disabled or bypassed when protection is active, while a proof verifier 1040 enables a proof-gated transfer 1050 into or out of a vault or wrapper balance 1060.

### 15.1 Flash-Loan-Assisted Atomic Migration

In some embodiments, the migration of liquidity-provider positions, lending positions, or other complex DeFi positions employs a flash loan to provide temporary liquidity for atomic restructuring. A representative flash-loan-assisted atomic migration comprises: borrowing temporary liquidity from a flash-loan provider; using the temporary liquidity to satisfy any required redemptions, swaps, or position-unwinding actions; redepositing the recovered assets into a quantum-safe vault, wrapped token contract, or proof-gated contract; and repaying the flash loan plus fees within the same atomic transaction. The atomic structure ensures that the migration either completes entirely or fails entirely, eliminating mid-migration exposure to market movements, partial executions, or interim quantum-vulnerability windows.

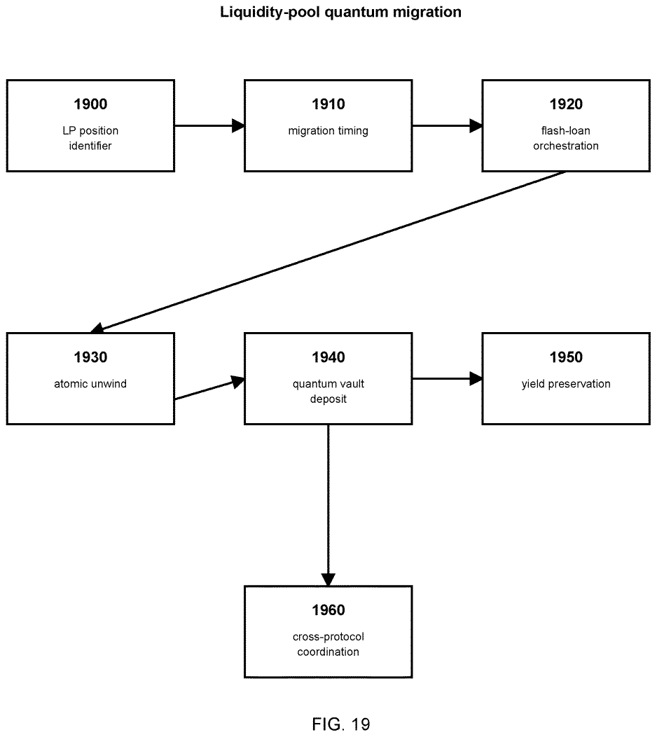

Referring to FIG. 19, a liquidity-provider position identifier 1900 may feed migration timing logic 1910 and flash-loan orchestration 1920. The migration can atomically unwind a position 1930, deposit recovered assets into a quantum vault 1940, preserve yield 1950 where possible, and coordinate across protocols 1960.

### 15.2 Impermanent-Loss-Aware Migration Timing

In a liquidity-provider migration, the migration module may compute impermanent-loss metrics and select migration timing to minimize losses, including but not limited to migration during low-volatility windows, migration in response to specific price thresholds, and migration upon detection of pool-rebalancing events. The migration timing logic may be informed by external price oracles, on-chain volatility metrics, governance signals, or threat-phase indicators.

### 15.3 Cross-Protocol and Cross-Chain Coordination

For positions distributed across multiple protocols or multiple chains, the migration module may coordinate atomic or near-atomic migration across protocols and chains, including but not limited to use of cross-chain message-passing systems, cross-chain bridge withdrawals, atomic-swap protocols, hash-time-locked contracts, and verifiable cross-chain proofs. Yield-preservation mechanisms may maintain accrued earnings during the transition without forced liquidation, where possible.

### 15.4 Quantum-Hardening Factory

In some embodiments, a quantum-hardening factory automatically converts blockchain assets or transaction flows from classical-key control to post-quantum-protected control. The factory may be implemented by a user wallet, exchange withdrawal system, custodian, merchant processor, bridge, token issuer, smart-contract factory, recovery service, transaction relay, or policy engine. An asset intake module identifies a wallet, token, account, bridge position, custodial balance, stable coin balance, liquidity position, channel balance, or transaction flow having quantum-vulnerable classical-key exposure. A policy module selects a protection mode, including but not limited to post-quantum signature authorization, zero-knowledge proof of seed knowledge, threshold custody, QD3 commitment registration, confidential batch registration, Merkle-root or accumulator-root registration, vault wrapping, proof-gated transfer, quantum lock activation, or protective custody.

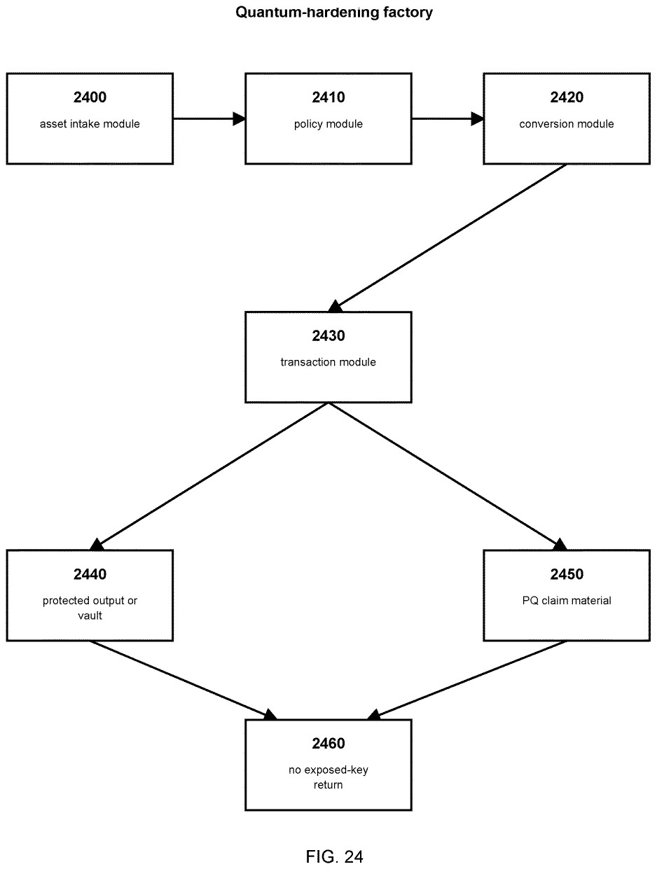

Referring to FIG. 24, the quantum-hardening factory includes an asset intake module 2400, policy module 2410, conversion module 2420, and transaction module 2430. The factory creates a protected output or vault 2440, binds or records post-quantum claim material 2450, and enforces a no exposed-key return condition 2460.

A conversion module creates a protected output, post-quantum address, vault, wrapper, account state, proof-gated balance, stable coin wrapper, reserve receipt, bridge receipt, or custody account. A transaction module executes or coordinates the conversion while reducing or preventing return of value to an exposed classical-key address. For UTXO-based assets, the transaction module may pay an intended recipient, sweep remaining value to a quantum-protected output, avoid change back to an exposed address, and record a QD3 attestation, fee-management output, child-pays-for-parent anchor, or post-quantum ownership commitment. For EVM or account-based assets, the conversion module may deploy or use a proof-gated vault, wrapper token, per-address quantum lock, post-quantum signature verifier, seed-commitment identity layer, or recovery contract. The factory may operate in user-initiated mode, opt-in preauthorization mode, exchange-withdrawal mode, bridge-exit mode, custodial emergency mode, token-issuer migration mode, or quantum-threat-triggered mode.

### 15.5 Post-Quantum EVM Contract Control, Stable Coin, and Quantum-Resistant Bridge

In some embodiments, post-quantum EVM contract control is applied to token contracts, vault contracts, bridge contracts, stable coin contracts, governance contracts, oracle contracts, upgradeable contracts, and administrative contracts. A contract-control registry identifies protected control points and maps each control point to a required authorization policy. The authorization policy may require post-quantum signatures, proof-gated authorization, seed-verified authorization, QD3-backed authorization, ERC-1271-compatible authorization, threshold authorization, or evidence-based authorization before protected operations execute. Protected operations may include token transfer, token approval, minting, burning, redemption, bridge movement, reserve movement, contract upgrade, owner change, role assignment, oracle update, governance execution, emergency pause, unpause, account recovery, or administrative action.

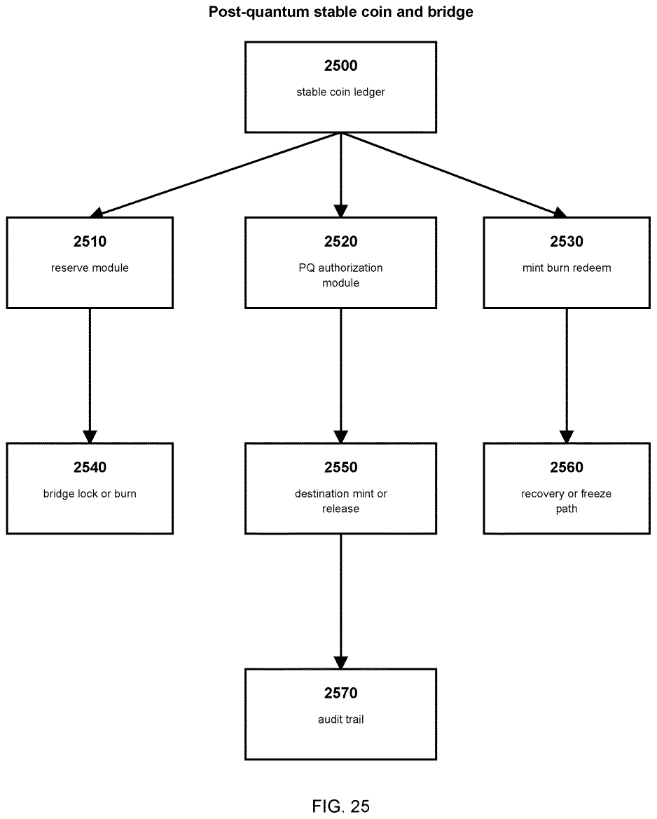

Referring to FIG. 25, a post-quantum stable coin or bridge embodiment may include a stable coin ledger 2500, reserve module 2510, post-quantum authorization module 2520, mint/burn/redeem module 2530, bridge lock or burn module 2540, destination mint or release module 2550, recovery or freeze path 2560, and audit trail 2570. These same elements may be generalized to non-stable token contracts, vault contracts, bridges, governance contracts, oracle contracts, upgradeable contracts, and administrative contracts.

In some embodiments, a stable coin is implemented as one application of the broader post-quantum EVM contract-control architecture. A stable coin ledger tracks balances of a stable coin or wrapped stable coin. A reserve module maintains backing assets, including but not limited to cash, treasury securities, tokenized treasury securities, overcollateralized crypto assets, insured deposits, segregated reserves, or other backing assets according to a reserve policy. An authorization module requires post-quantum signatures, zero-knowledge proofs of hierarchical-deterministic seed knowledge, QD3 commitment reveals, threshold signatures, hardware-wallet attestations, ERC-1271-compatible validation results, account-abstraction validation results, smart-contract proofs, or combinations thereof before selected stable coin operations execute.

A recovery module may freeze, reissue, migrate, redeem, rebind, or restore stable coin balances based on pre-compromise evidence rather than relying solely on a classical signature produced after public-key exposure. The recovery module may use the distributed management ledger, QD3 timestamped commitments, seed evidence, transaction-origin evidence, court or arbitration attestations, exchange records, custodian records, reserve records, or challenge windows described herein. A bridge module may require post-quantum or proof-gated authorization before minting, burning, locking, unlocking, or releasing bridged stable coin value. The bridge module may support source-chain lock or burn, destination-chain mint or release, recovery or freeze paths, reserve reconciliation, proof-of-reserves, and audit trails. In some embodiments, an existing stable coin is migrated into a quantum-protected wrapper while preserving redemption rights against backing assets.

### 15.6 Token Mode Switching and Cross-Chain Security Boundary

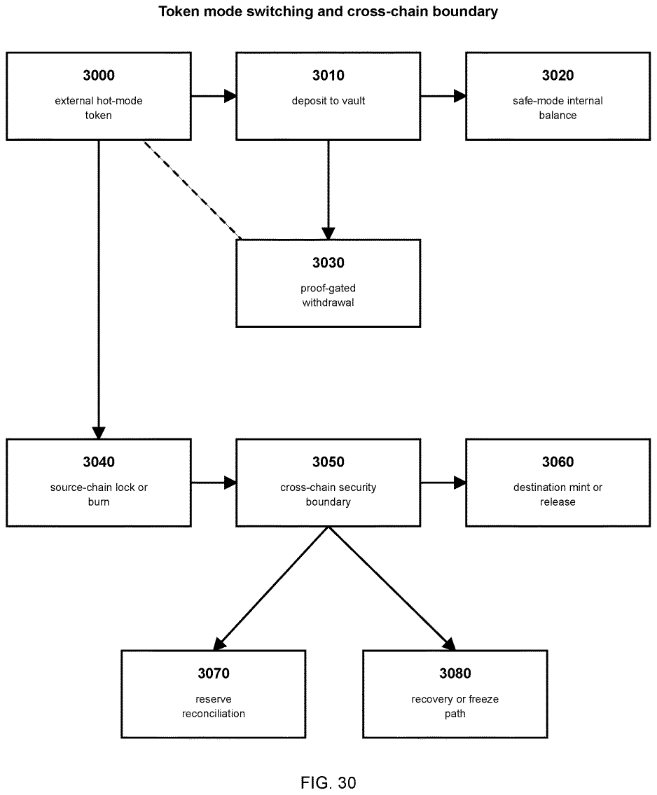

As shown in FIG. 30, token systems may operate in a hot mode and a safe mode. In hot mode, an external hot-mode token 3000 remains compatible with ordinary wallets, exchanges, decentralized exchanges, lending protocols, and bridge contracts. A deposit to vault operation 3010 moves value into a safe-mode internal balance 3020 under a seed commitment, post-quantum key commitment, or proof-gated identity. A proof-gated withdrawal 3030 transfers value back to the external token layer only after validating a post-quantum signature, zero-knowledge seed proof, QD3 reveal, threshold authorization, or recovery determination.

The same architecture may define a cross-chain security boundary. On a source chain, a source-chain lock or burn module 3040 operates only after receiving the required post-quantum or proof-gated authorization. A cross-chain security boundary 3050 checks proof validity, replay protection, chain identifiers, nonce state, reserve conditions, and recovery or freeze policies. On a destination chain, a destination mint or release module 3060 acts only after the boundary approves the event. Reserve reconciliation 3070 and recovery or freeze path 3080 may ensure that hot-mode tokens, safe-mode vault balances, wrapped tokens, bridge receipts, and stable coin reserves remain consistent across chains.

### 16. Non-Sovereign Wealth Fund and Yield Handling

In some embodiments, assets under protective custody are aggregated into a managed pool or non-sovereign wealth fund. The fund may maintain full principal reserves for owner claims while using conservative strategies to generate yield. Returns may be allocated to owners, public goods, insurance reserves, operational expenses, or governance-approved causes. Transparent accounting, proof-of-reserves, distributed control, and audit trails may preserve claimant rights.

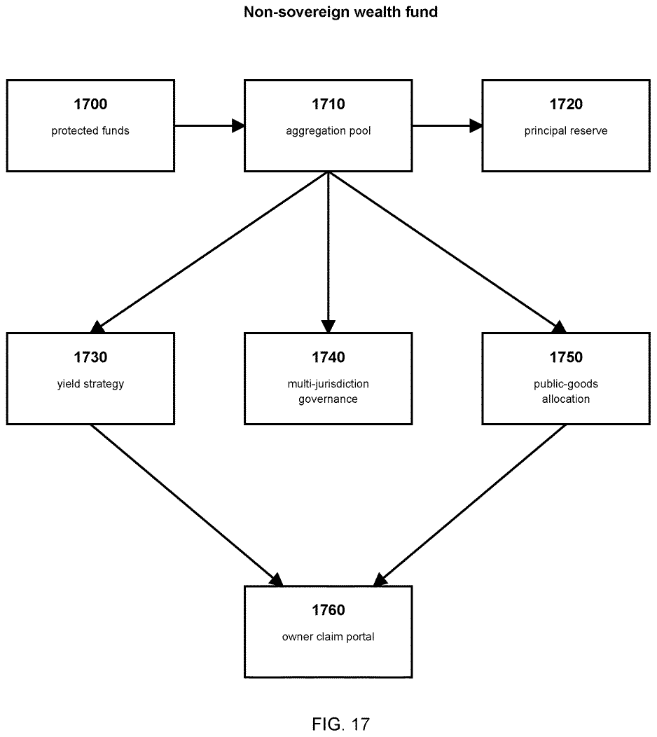

Referring to FIG. 17, protected funds 1700 may be aggregated into an aggregation pool 1710 while a principal reserve 1720 preserves claimant recovery rights. A yield strategy 1730 may be controlled by multi-jurisdiction governance 1740, with a portion allocated to public goods 1750 where permitted. An owner claim portal 1760 provides a path for original owners or other rightful claimants to recover principal and any applicable appreciation.

The wealth-fund embodiment is optional. The core invention does not require investment of protected assets. In implementations that generate yield, claimants may receive principal plus proportional appreciation, subject to policy, law, custody agreement, or arbitration result.

### 16.1 Aggregation, Reserves, and Yield Generation

In a preferred embodiment, an aggregation smart contract or governance-controlled pool collects protected funds from multiple custody addresses through systematic processes including but not limited to automated address sweeping, batch transaction processing, fee-optimization algorithms, privacy-preserving aggregation protocols, cross-chain collection bridges, and real-time balance monitoring. The fund maintains principal reserves sufficient to satisfy all foreseeable owner claims, including but not limited to a one-hundred-percent reserve target on protected principal. Yield is generated through conservative decentralized-finance strategies that maintain principal availability, including but not limited to lending-pool deposits, automated market-making with hedged positions, yield-farming aggregation, liquidity-provision rewards, staking-delegation services, options-strategy programs, and other strategies governed by risk-management policies.

### 16.2 Distributed Multi-Jurisdiction Governance

The aggregation smart contract or pool is controlled by multi-signature governance distributed across multiple jurisdictions, multiple time zones, and multiple independent operating entities. Governance functions include but are not limited to upgradeable proxy patterns with controlled upgrade procedures, multi-signature transaction authorization modules, emergency-pause functionality, fund-isolation chambers preventing cross-contamination, audit-logging systems producing immutable records, and gas-efficient operations.

### 16.3 Proof-of-Reserves and Transparent Accounting

In some embodiments, the fund publishes regular proof-of-reserves attestations cryptographically demonstrating that principal reserves meet or exceed obligations. Real-time net-asset-value calculations, individual contribution tracking, proportional ownership records, historical performance charts, and currency-conversion displays may be provided through public dashboards.

### 16.4 Public-Goods Allocation and AI-Oracle Verification

In some embodiments, yield generated by the fund, or a portion thereof, is allocated to verified public-goods projects through structured processes including but not limited to: proposal-submission portals; community voting mechanisms with quadratic voting to prevent whale dominance; impact-assessment criteria evaluated by AI oracles; milestone-tracking systems; recipient-verification protocols; transparent reporting requirements; success-metrics evaluation through oracle networks; and emergency-reallocation procedures where projects fail to meet milestones. The AI oracles may verify real-world impact metrics and trigger fund recovery from failed initiatives. Successful projects may receive continued support based on demonstrated outcomes.

### 16.5 Owner Claim and Appreciation Recovery

Original owners retain perpetual rights to claim the principal of their protected assets, plus proportional appreciation generated by the fund, upon successful claim verification through the recovery framework described in Section 11. Claim-portal interfaces may provide identity-verification workflows, documentation-upload features, claim-status tracking, secure communication channels, multi-language support, accessibility compliance, and customer-service integration.

### 17. Security Considerations

The system should use domain-separated hashes for commitments, strong random salts, post-quantum-secure algorithms where post-quantum assurance is required, algorithm agility for future migrations, and independent custody keys. Salts should be long enough to resist brute-force discovery of protected addresses. Commitment formats should include versioning and chain identifiers. Reveals should bind to specific claim contexts to prevent replay across chains or proceedings.

Zero-knowledge proof systems should be selected based on the intended threat model. Pre-quantum deployments may use efficient proof systems for convenience, but post-quantum claim resolution preferably uses hash-based or otherwise post-quantum-resistant proof systems. Custody systems should avoid unilateral control, maintain auditability, and define clear recovery and challenge rules.

### 18. EXAMPLE EMBODIMENTS

### Example 1: Single-Address Confidential QD3

A user owns a never-spent P2WPKH Bitcoin address. The user generates an ML-DSA key pair and a random salt. The user computes a commitment to the Bitcoin address, the hash of the ML-DSA public key, the hash of a claim signature, and a migration policy. The user pays from a separate wallet to record an OP_RETURN commitment. Years later, a migration fork recognizes QD3 records. The user reveals the address, salt, ML-DSA public key, claim signature, and policy. The fork verifier recomputes the commitment and credits the user in a post-quantum ledger without the original registration having exposed the address public key.

### Example 2: Multi-Address Batch QD3

A wallet protects one hundred addresses. For each address, the wallet generates a salted claim leaf. The wallet adds decoy leaves and pads the tree to a fixed size of two hundred fifty-six leaves. Only the Merkle root is written to Bitcoin. Later, one address enters a recovery proceeding. The owner reveals that address's leaf data and a Merkle proof. The verifier confirms inclusion in the old root without learning the other addresses in the wallet.

### Example 3: QSAVE Protective Custody

A QSAVE scanner identifies a high-value P2PK output with an exposed public key after a quantum-threat threshold has been met. A legally authorized protective custody group moves the asset to a distributed multisignature address. The custody action is logged. A claimant later presents a pre-existing QD3 reveal and post-quantum signature matching a timestamped commitment. After a challenge period, the QSAVE system transfers the asset to the claimant's quantum-safe address.

### Example 4: Recovery without QD3

A deceased owner's heir discovers a hardware wallet after quantum compromise. No QD3 record exists. The heir submits probate documents, exchange purchase records, hardware-wallet receipts, wallet backup fragments, and a zero-knowledge proof of seed-derived address control. The recovery framework scores the evidence, allows challenges, and authorizes release from protective custody if no superior claim is received.

### Example 5: PQP Transaction

A wallet detects that spending from a reused address will reveal or has revealed a public key. It constructs a transaction paying the requested recipient, sweeping the full remaining balance to a quantum-safe output, and embedding a QD3 attestation. The transaction includes a change output capable of CPFP acceleration. No funds return to the exposed address.

### Example 6: Proof-Gated Token Transfer

An EVM token contract stores a commitment to a wallet seed or post-quantum key. When quantum lock is enabled, ordinary transfers from the account revert. A transfer succeeds only when accompanied by a valid proof that the sender knows the committed seed or a valid signature from the committed post-quantum key.

### Example 7: Quantum Vault Wrapping

A user wraps an existing ERC-20 token holding by depositing tokens into a quantum vault contract that issues vault-token receipts keyed by a hash commitment of the user's hierarchical-deterministic seed. Subsequent transfers between vault accounts require zero-knowledge proofs of seed knowledge rather than elliptic-curve signatures, providing quantum protection without requiring modification of the original ERC-20 token contract.

### Example 8: Lightning Channel Closure with Recursive PQP

A Lightning Network node detects a quantum-threat-phase transition and initiates closure of all channels using pre-signed PQP-compliant emergency closing transactions stored in a watchtower. Each closing transaction sweeps channel funds to fresh quantum-safe addresses with QD3 attestations and CPFP-capable change outputs. A subsequent CPFP child transaction, also constructed in PQP-compliant form, accelerates confirmation by sweeping the change output to a further quantum-safe address.

### Example 9: Liquidity-Pool Migration Via Flash Loan

An automated migration module identifies a vulnerable liquidity-provider position and executes an atomic migration using a flash loan: the module borrows temporary liquidity, redeems the LP position, deposits the recovered tokens into a quantum-vault wrapper, and repays the flash loan within a single atomic transaction, all within a single block.

### 19. Quantum-Safe Address Format

In some embodiments, quantum-safe addresses are encoded using Bech32m encoding (BIP-350) for superior error-detection properties. A representative address format comprises a human-readable prefix indicating mainnet (e.g., “qk1”) or testnet (e.g., “tqk1”), a separator character, a witness-version field (e.g., 0), and a data field comprising a hash of a post-quantum public key. A representative encoding is the SHA-256 hash of an ML-DSA-65 public key, encoded as Bech32m, producing addresses of representative length consistent with existing Bech32m address formats. Other post-quantum signature algorithms may be supported through corresponding hash encodings or alternative version fields.

### 20. Taproot Dual-Leaf Embodiment

In some embodiments, a Taproot output is constructed with: an internal key rendered provably unspendable through use of a Nothing-Up-My-Sleeve construction (e.g., the value [0x02, 0x00×32] or a similar provably-unspendable point); and a script tree comprising one or more leaves, including a leaf providing a quantum-safe spending path that requires verification of a post-quantum signature against a committed post-quantum public key, and optionally a classical leaf providing a time-locked classical recovery path. Spends from the output are forced through the script-tree leaves because the internal key path cannot produce a valid signature.

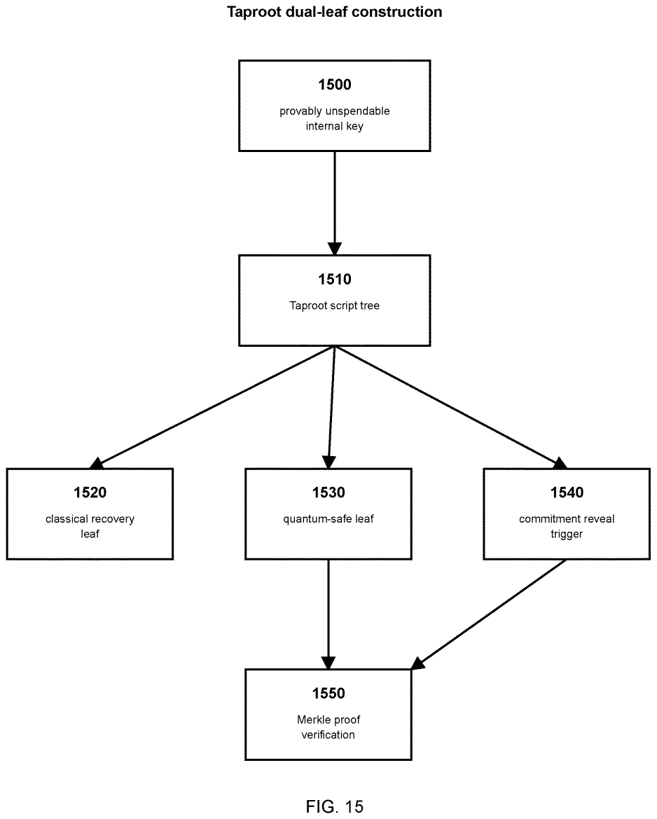

Referring to FIG. 15, the Taproot embodiment may include a provably unspendable internal key 1500 and a Taproot script tree 1510. The script tree may include a classical recovery leaf 1520, a quantum-safe leaf 1530, a commitment reveal trigger 1540, and Merkle proof verification 1550.

This embodiment depends on a Bitcoin protocol enhancement that recognizes provably unspendable internal keys and enforces script-only spending, and is not enabled under the present consensus rules. The invention provides immediate deployment capability upon protocol activation.

A representative dual-leaf construction comprises a root commitment referencing both spending paths with the disabled key path; a key-path branch rendered unspendable through the provably-unspendable internal key; a quantum-safe script-path branch with ML-DSA-65 signature verification; commitment-reveal trigger conditions binding the post-quantum key through hash verification; and Merkle-proof validation ensuring efficient on-chain spending verification.

### 21. Proposed OP_QCLAIM Opcode

In some embodiments, a proposed Bitcoin script opcode, designated OP_QCLAIM, provides native on-chain quantum-claim verification. A representative OP_QCLAIM script structure comprises: script-version bytes ensuring backward compatibility; an operation code activating quantum-claim verification; commitment-hash validation confirming pre-existing claims; signature-verification paths supporting both classical and post-quantum signature algorithms; time-lock conditions preventing premature claims; and fallback mechanisms maintaining backward compatibility with existing Bitcoin script interpreters through OP_NOP expansion.

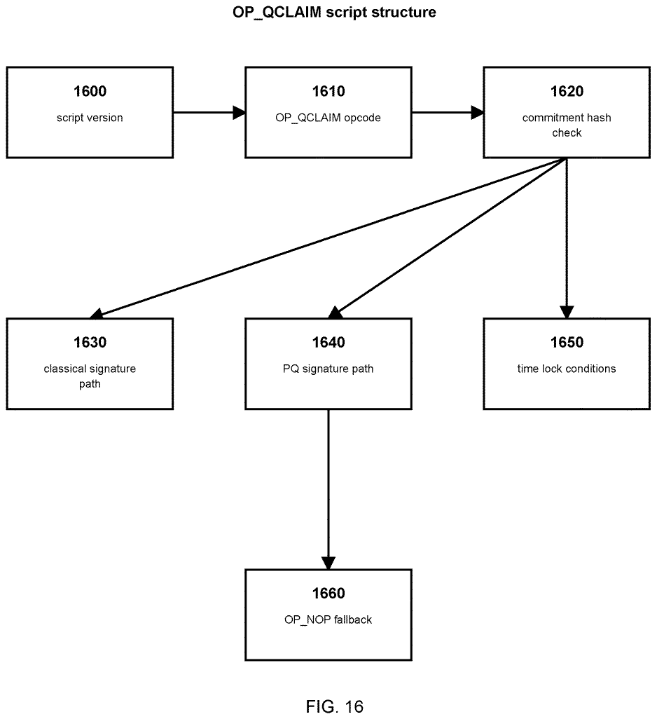

Referring to FIG. 16, a representative OP_QCLAIM structure includes script version bytes 1600, an OP_QCLAIM opcode 1610, a commitment hash check 1620, a classical signature path 1630, a post-quantum signature path 1640, time-lock conditions 1650, and OP_NOP fallback 1660 for backward-compatible deployment.

This embodiment depends on a Bitcoin consensus change introducing the proposed opcode and is not enabled under the present consensus rules. The invention provides immediate deployment capability upon protocol activation.

### 22. Unified Hierarchical-Deterministic Derivation of Classical and Post-Quantum Keys

In some embodiments, a single hierarchical-deterministic seed derives both a classical elliptic-curve keypair and a post-quantum keypair through domain-separated key-derivation functions. A representative construction comprises:

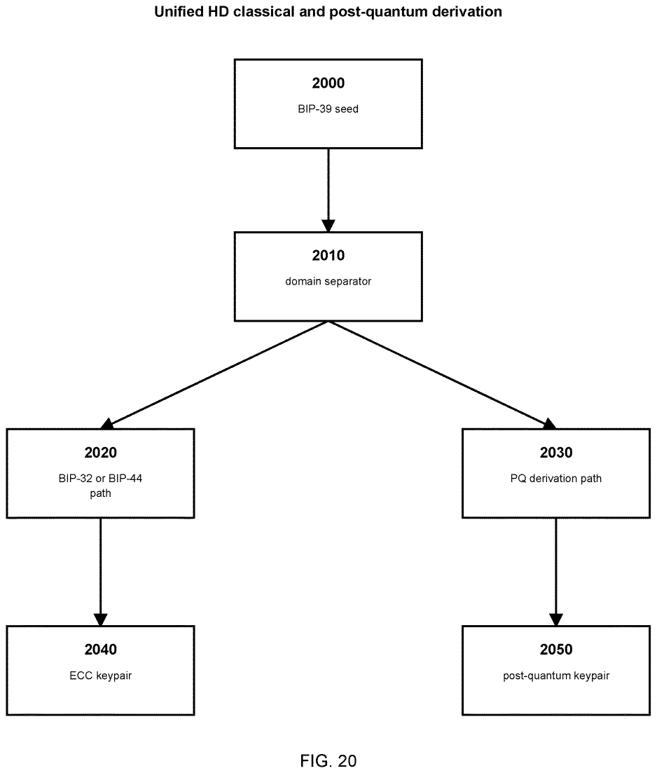

Referring to FIG. 20, a BIP-39 seed 2000 is processed with a domain separator 2010 into at least two derivation branches. A BIP-32 or BIP-44 path 2020 produces an elliptic-curve keypair 2040, while a post-quantum derivation path 2030 produces a post-quantum keypair 2050.
a master seed S (e.g., a BIP-39 mnemonic-derived seed);
a domain-separated classical derivation path producing a BIP-32/BIP-44 elliptic-curve keypair (e.g., m/44′/0′/0′/0/0 for Bitcoin or m/44′/60′/0′/0/0 for Ethereum);
a domain-separated post-quantum derivation path producing an ML-DSA-65, Falcon, or SLH-DSA keypair under a separate purpose code (e.g., m/3077′/0′/0′/0/0′ for a quantum hierarchical wallet); and
a domain separator distinguishing the two derivation domains, preventing cross-domain key recovery and supporting algorithm agility.

The unified derivation enables a single seed to back both classical and post-quantum signatures, simplifies key management, supports algorithm agility through alternative post-quantum derivation paths, and permits proofs of joint ownership where required.

### 23. Proof-Gated Quantum-Locked Token Standard

In some embodiments, an account-based blockchain token standard extends a baseline fungible token standard (e.g., ERC-20) with per-address quantum-lock functionality. Referring again to FIG. 10, the EVM account or token 1000 is controlled by the quantum lock state 1010 and seed or post-quantum commitment 1020, so that a standard transfer gate 1030 may be replaced or supplemented by a proof verifier 1040 and proof-gated transfer 1050 before value reaches a vault or wrapper balance 1060. The contract state comprises:
a mapping of addresses to hash commitments of hierarchical-deterministic seeds;
a mapping of addresses to per-address nonces preventing replay of previously valid proofs; and
a mapping of addresses to quantum-lock states indicating whether quantum protection is active.

The contract provides:
an enable-quantum-lock function setting the seed-hash commitment for a calling address and activating the quantum lock;
a disable-quantum-lock function deactivating the quantum lock only upon presentation of a valid zero-knowledge proof of seed knowledge, preventing an attacker possessing only a derived elliptic-curve private key from disabling the protection;
a standard transfer function that reverts when called from a quantum-locked address;
a proof-gated transfer function (e.g., transferZK) accepting a zero-knowledge proof of seed knowledge and the per-address nonce, verifying the proof and the matching seed commitment, incrementing the nonce, and executing the transfer.

When the quantum lock is enabled, standard transfer and transferFrom functions revert regardless of the validity of any classical signature. When the quantum lock is disabled, standard transfer functions operate as in the baseline token standard, providing full compatibility with existing decentralized exchanges, lending markets, and bridges. Users may explicitly choose between locked mode (post-quantum security through ZK proofs) and unlocked mode (classical security with full ecosystem compatibility) on a per-address basis.

### 24. Three-Layer Token/Vault/Identity Custody Architecture

In some embodiments, a three-layer custody architecture protects fungible tokens. The layers comprise:

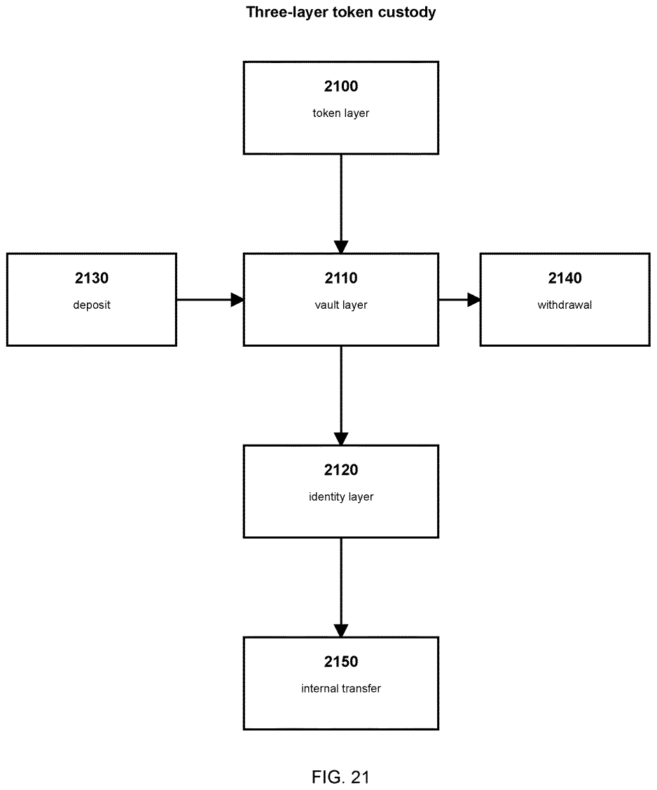

Referring to FIG. 21, the three-layer architecture includes a token layer 2100, a vault layer 2110, and an identity layer 2120. Deposit 2130 moves value from the token layer 2100 into the vault layer 2110, withdrawal 2140 moves value out after proof verification, and internal transfer 2150 updates balances within the protected identity layer 2120.
a token layer providing a standard token interface (e.g., ERC-20 surface) exposed to external wallets, exchanges, and decentralized applications;
a vault layer comprising a smart contract that holds tokens transferred from the token layer and maintains internal balance accounting; and
an identity layer in which internal vault balances are keyed not by elliptic-curve-controlled accounts but by hash commitments of hierarchical-deterministic seeds. Operations on the architecture comprise:
a deposit function transferring tokens from the token layer to the vault and crediting an internal balance under a seed-commitment identifier;
a withdrawal function transferring tokens from the vault back to the token layer upon successful verification of a zero-knowledge proof of seed knowledge;
an internal transfer function updating internal balances within the vault between seed-commitment identifiers without external token-layer interaction; and
a recovery interface permitting authorized recovery actions upon multi-tier evidence and arbitration.

The three-layer architecture supports wrapping of existing fungible tokens to provide quantum protection without modification of the original token contract, supports a “hot mode” of external transactability (when tokens are at the token layer) and a “safe mode” of quantum-resistant custody (when tokens are at the vault layer), and supports cross-chain extension through bridge contracts.

### 25. Multi-Party Coordination and Cascade Prevention

In some embodiments, the system coordinates protective actions across multiple holders to prevent cascade failures during a quantum-transition window. Cascade-failure modes include but are not limited to: simultaneous spend collisions where multiple holders attempt to migrate from overlapping address sets at the same time; mempool congestion where simultaneous protective sweeps exceed available block space; fee-market shocks where simultaneous high-fee protective sweeps inflate fees beyond non-protective transactions' affordability; and miner-extractable-value extraction targeting predictable migration patterns.

A representative coordination protocol comprises: a registry of intended protective actions; a scheduling layer assigning sweep slots to holders based on threat priority, address vulnerability scoring, and transaction-size budgeting; a fee-coordination layer ensuring sustainable fee markets; a privacy layer preventing public disclosure of intended targets; and an emergency-override mechanism for high-priority addresses.

### 26. Browser-Based Implementation

In some embodiments, the system is implemented in a web-browser environment using browser-native cryptographic primitives. A representative implementation comprises: a Web Crypto API providing entropy generation in compliance with applicable entropy standards (e.g., NIST Special Publication 800-90B); single-source entropy generation from crypto.getRandom Values to avoid security degradation that may result from mixing multiple entropy sources; post-quantum cryptographic libraries operating in the browser environment (e.g., a Noble Post-Quantum library or equivalent); a secure-context isolation model ensuring private keys are not exposed to untrusted scripts; and an optional integration with browser-based hardware-token signing for hardware-wallet-backed operations.

### 27. Quantum Vault Embodiment

In some embodiments, a quantum vault is a smart contract that stores tokens, native assets, or vault-token receipts on behalf of a user, with access governed by a commitment to a wallet seed or to a post-quantum public key, and protected by a per-vault quantum-lock state. The vault may be implemented using the vault or wrapper, quantum lock, seed identity, proof verifier, and protected transfer elements represented generally in FIGS. 10, 21, and 22. Standard withdrawal functions revert when the quantum lock is active. A proof-gated withdrawal function permits transfer only upon verification of a valid post-quantum signature, a valid zero-knowledge proof of seed knowledge, or both. A recovery contract or recovery policy permits release of vault assets upon successful claim verification through the recovery framework described in Section 11.

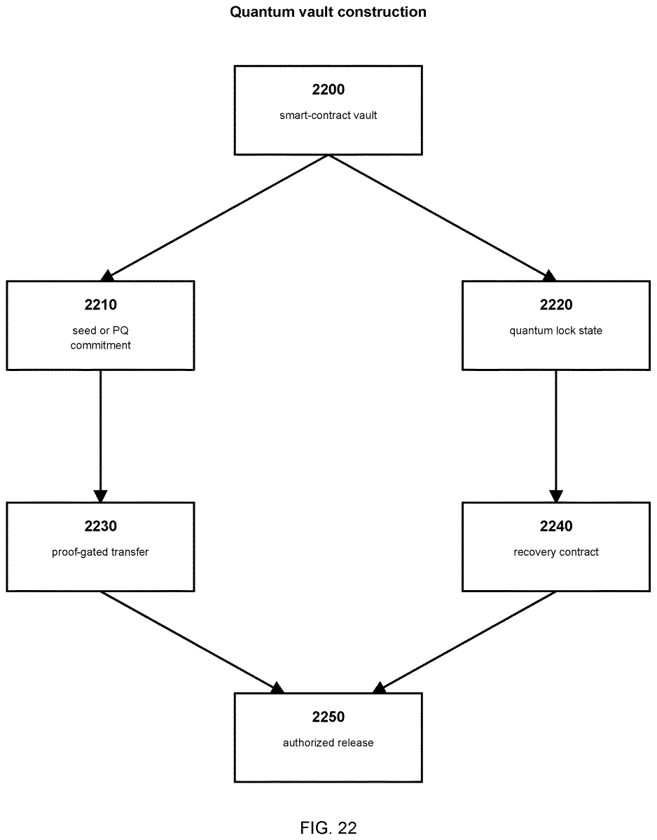

Referring to FIG. 22, the quantum vault embodiment includes a smart-contract vault 2200 associated with a seed or post-quantum commitment 2210 and a quantum lock state 2220. A proof-gated transfer function 2230 and a recovery contract 2240 may each authorize an authorized release 2250 under different policy conditions.

The quantum vault may be deployed as: an account-level vault for individual users; a multi-account vault for institutional custody; a wrapped-token vault providing quantum protection for an external token contract; or a cross-chain vault providing quantum protection across multiple blockchains.

What is claimed is:

1. A computer-implemented method for resolving ownership of a blockchain asset after compromise of a classical public-key cryptographic scheme, the method comprising:
receiving a claim to the blockchain asset; receiving asymmetric ownership evidence that includes information unavailable to a party that merely derives a classical private key from an exposed public key of the blockchain asset, the asymmetric ownership evidence including at least one of seed evidence, pre-compromise timestamped watermark evidence, transaction-origin evidence, or third-party attestation evidence;
cryptographically verifying at least one proof object associated with the asymmetric ownership evidence; comparing the asymmetric ownership evidence with at least one pre-compromise record; and authorizing one or more of migration, release, recognition, or adjudication of the blockchain asset when the asymmetric ownership evidence satisfies a recovery policy.

2. The method of claim 1, wherein the seed evidence comprises one or more of a zero-knowledge proof, a signed statement, a wallet-derived proof, or a recovery record showing that one or more of a BIP-39 seed, BIP-32 derivation path, BIP-44 derivation path, BIP-84 derivation path, BIP-86 derivation path, EVM derivation path, or hardware-wallet derivation path produces one or more of an address, account, public-key hash, script descriptor, or token position corresponding to the blockchain asset.

3. The method of claim 1, wherein the timestamped watermark evidence comprises one or more of a signed ownership message, QD3 commitment, salted address commitment, Merkle root, accumulator root, OP_RETURN record, Taproot commitment, smart-contract event, rollup record, or other watermark recorded with a verifiable time stamp or block height before one or more of a quantum-transition event, migration cutoff, recovery window, fork snapshot, or arbitration deadline.

4. The method of claim 1, wherein the transaction-origin evidence comprises one or more of mining receipts, exchange purchase records, coinbase records, deposit records, funding transaction records, payroll records, treasury records, or other receipts indicating that the claimant placed coins, tokens, or other value into an address rather than merely paid value to another party.

5. The method of claim 1, wherein the blockchain asset comprises one or more of a Bitcoin UTXO, Bitcoin address, Ethereum account, EVM account, fungible-token balance, non-fungible-token position, smart-contract position, bridge position, staking position, payment-channel balance, or liquidity-provider position.

6. The method of claim 1, wherein the third-party attestation evidence comprises one or more of a court order, probate record, trustee attestation, exchange attestation, custodian attestation, identity attestation, estate document, arbitration record, or social attestation.

7. The method of claim 1, wherein the recovery policy gives greater evidentiary weight to seed evidence and timestamped watermark evidence than to a classical signature generated after public-key exposure.

8. The method of claim 1, further comprising opening a challenge period in which a competing claimant may submit superior pre-compromise evidence, wherein authorizing migration, release, recognition, or adjudication comprises distinguishing a legitimate owner from a party that obtained the classical private key by quantum computation from the exposed public key.

9. A distributed management ledger system for coordinating human-trust migration of quantum-vulnerable blockchain assets, the system comprising: a registry configured to record one or more of migration candidates, protective-custody actions, recovery claims, challenge periods, custodian decisions, or settlement events; a governance layer configured to accept attestations from one or more of independent custodians, exchanges, miners, trustees, courts, arbitrators, auditors, or community representatives; an evidence layer configured to store or link cryptographic commitments, hashes, digital signatures, proof identifiers, timestamp records, or append-only audit entries that bind submitted evidence to specific migration or recovery events; a consensus or voting layer configured to determine whether one or more of a migration, release, reserve allocation, or recovery action should proceed; and an audit layer configured to publish a human-readable and machine-verifiable history of the migration process.

10. The system of claim 9, wherein the registry is implemented on one or more of a blockchain, rollup, sidechain, database with public commitments, append-only log, notarized ledger, transparency log, decentralized autonomous organization ledger, or federated ledger.

11. The system of claim 9, wherein the governance layer assigns different roles or weights to one or more of technical validators, legal validators, custodians, auditors, exchanges, miners, trustees, courts, arbitrators, heirs, or affected asset holders.

12. The system of claim 9, wherein the distributed management ledger preserves a record that a migration decision was made by a human trust network rather than by unilateral action of a single custodian, issuer, bridge operator, exchange, or software provider.

13. The system of claim 9, further comprising a non-sovereign wealth fund module, a reserve module, or both, configured to hold protected assets, maintain principal reserves, account for appreciation or yield, and preserve an owner recovery right while disputed claims are pending.

14. The system of claim 9, wherein the consensus or voting layer applies one or more of a claim quality score, refundable stake, zero-stake treatment for superior cryptographic proof, blind arbitration, challenge window, decay period, or competing-claim resolution.

15. The system of claim 9, wherein the distributed management ledger supports migration of one or more of dormant wallets, inherited assets, lost wallets, legally supervised estates, exchange-held assets, bridge-held assets, stable coin reserves, or assets whose owners are unavailable during a quantum-transition event.

16. A quantum-hardening factory system for automatically converting blockchain assets from classical-key control to post-quantum-protected control, the system comprising: an asset intake module configured to identify one or more of a wallet, token, account, bridge position, custodial balance, or transaction flow having quantum-vulnerable classical-key exposure; a policy module configured to select a post-quantum protection mode; a conversion module configured to create one or more of a protected output, vault, wrapper, account state, or proof-gated balance; and a transaction module configured to execute or coordinate conversion of the blockchain asset while reducing or preventing return of value to an exposed classical-key address.

17. The system of claim 16, wherein for a Bitcoin or UTXO-based asset the transaction module constructs a transaction that pays an intended recipient, sweeps remaining value to a quantum-protected output, avoids change back to an exposed address, and records one or more of a QD3 attestation, fee-management output, child-pays-for-parent anchor, or post-quantum ownership commitment.

18. The system of claim 16, wherein for an EVM or account-based asset the conversion module deploys or uses one or more of a proof-gated vault, ERC-20 wrapper, ERC-21-style lock, per-address quantum lock, post-quantum signature verifier, or seed-commitment identity layer.

19. The system of claim 16, wherein the asset intake module is implemented by one or more of a user wallet, exchange withdrawal system, custodian, merchant processor, bridge, token issuer, smart-contract factory, recovery service, or transaction relay.

20. The system of claim 16, wherein the post-quantum protection mode comprises one or more of post-quantum signature authorization, zero-knowledge proof of seed knowledge, threshold custody, confidential batch registration, Merkle-root registration, accumulator-root registration, proof-gated transfer, chain-native two-factor spending, or chain-native QD3-backed claim verification.

21. The system of claim 16, wherein in the chain-native two-factor spending mode upgraded validating node software requires a transaction spending the blockchain asset to include both a valid classical signature under an existing elliptic-curve key and a valid zero-knowledge proof that a spender knows a wallet seed, derivation path, or seed-derived secret that produces an address, public-key hash, script descriptor, or account corresponding to the blockchain asset, and wherein a post-quantum-hardened hierarchical-deterministic wallet automatically derives the relevant path and attaches proof data to the transaction, witness, annex, script path, proof channel, sidecar record, or other field recognized by the upgraded validating node software.

22. The system of claim 16, wherein in the chain-native QD3-backed claim verification mode upgraded validating node software verifies reveal material supplied with a transaction against an earlier timestamped QD3 commitment, QD3 root, Merkle root, accumulator root, Taproot commitment, OP_RETURN record, sidechain commitment, rollup commitment, or other public-ledger commitment, and wherein a post-quantum-hardened wallet automatically supplies one or more of a salt, domain separator, asset identifier, address identifier, post-quantum public-key hash, claim context, policy descriptor, zero-knowledge proof, post-quantum signature, Merkle proof, accumulator witness, or other proof material without requiring communication with a QSAVE server.

23. The system of claim 16, wherein the conversion module records a timestamped commitment to post-quantum claim material without revealing any protected address, protected public key, full post-quantum public key, or number of protected addresses.

24. A post-quantum EVM smart-contract control system comprising: a contract-control registry configured to identify one or more protected control points of an EVM-compatible account or smart contract; an authorization module configured to require, before execution of a protected operation at the one or more protected control points, at least one post-quantum-safe authentication route comprising one or more of a post-quantum digital signature, proof-gated authorization proof, seed-verified hierarchical-deterministic wallet proof, QD3-backed timestamped commitment-and-reveal proof, ERC-1271-compatible contract-signature validation result, or cryptographic proof mechanism resistant to compromise of a classical elliptic-curve private key; a validation module configured to expose or use a contract validation path comprising one or more of an ERC-1271 signature-validation interface, account-abstraction validation function, proof verifier, or post-quantum signature verifier; and a recovery module configured to preserve or restore control when one or more classical control keys are compromised by a quantum attack.

25. The system of claim 24, wherein the system is implemented as one or more of an Eth VaultPQ contract, ERC20PQ token, ERC-20-compatible token wrapper, proof-gated vault, account-abstraction wallet, ERC-1271 validator, quantum-safe contract account, vault receipt, bridge token, Bitcoin-anchored token, rollup token, multi-chain token, post-quantum stable coin, or USDPQ stable coin.

26. The system of claim 24, wherein the protected operation comprises one or more of token transfer, token approval, minting, burning, redemption, bridge locking, bridge unlocking, bridge release, reserve movement, contract upgrade, owner change, role assignment, oracle update, governance execution, emergency pause, unpause, account recovery, or administrative action.

27. The system of claim 24, wherein the authorization module verifies one or more of a post-quantum signature, zero-knowledge proof of hierarchical deterministic seed knowledge, QD3 commitment reveal, threshold signature, hardware-wallet attestation, smart-contract proof, ERC-1271 validation result, account-abstraction validation result, Merkle proof, accumulator proof, or contract-policy proof.

28. The system of claim 24, wherein the system is implemented as one or more of a post-quantum stable coin or a stable coin wrapper having a stable coin ledger and a reserve module that maintains backing assets selected from one or more of cash, treasury securities, tokenized treasury securities, overcollateralized crypto assets, insured deposits, segregated reserves, or other backing assets according to a reserve policy.

29. The system of claim 24, wherein the system includes a bridge module that requires post-quantum authorization, proof-gated authorization, ERC-1271-compatible authorization, or combinations thereof before one or more of minting, burning, locking, unlocking, or releasing bridged value.

30. The system of claim 24, wherein the system migrates an existing token, stable coin, vault, bridge, contract account, externally owned account control point, or contract control point into a quantum-protected wrapper, validator, vault, or account structure while preserving one or more of redemption rights, governance rights, upgrade rights, bridge rights, reserve rights, or user balance rights.
